(19) United States
(12) Patent Application Publication
(10) Pub. No.: US 2026/0074561 A1
(43) Pub. Date: Mar. 12, 2026

(54) System and Method for AI-Orchestrated Multi-Source Renewable Energy Harvesting and Decentralized Energy Trading

(71) Applicant: Samuel Odeh, Burr Ridge, IL (US)

(72) Inventor: Samuel Odeh, Burr Ridge, IL (US)

(21) Appl. No.: 19/383,684

(22) Filed: Nov. 9, 2025

(51) Int. Cl. H02J 50/00; H04L 9/00; H04L 9/08

(52) U.S. Cl. CPC H02J 50/001; H04L 9/0852; H04L 9/50; H02J 2101/28

(57) ABSTRACT

A system and method are disclosed for AI-orchestrated multi-source renewable energy harvesting and decentralized trading. A plurality of energy harvesting nodes convert renewable resources, including solar irradiance, wind, hydrodynamic flow, salinity gradients, geothermal heat, and waste-heat streams, into electrical power. Each node includes a sensor array that measures operating and environmental parameters and an edge AI processing unit that predicts performance degradation and computes control actions to maximize net power output subject to stress constraints. A power conversion subsystem conditions the generated power for delivery to storage, microgrids, or utility grids. A blockchain-based orchestration layer receives validated energy summaries, tokenizes discrete energy quanta as digital energy tokens with provenance metadata, and executes smart contracts for peer-to-peer trading, dynamic pricing, and programmable revenue distribution. A fleet-level AI coordination module performs federated learning across nodes and coordinates dispatch and curtailment among heterogeneous modalities, improving portfolio efficiency, grid stability, and environmental accounting.

The present invention relates generally to renewable energy systems and, more particularly, to systems and methods for orchestrating multi-source renewable energy harvesting and decentralized energy trading using artificial intelligence. The disclosed technology integrates heterogeneous renewable generation assets, edge artificial intelligence, Internet-of-Things (IOT) sensing, power electronic conversion, and distributed ledger infrastructure into a unified architecture.

In certain embodiments, the invention concerns control and optimization of distributed energy resources including, but not limited to, solar photovoltaic arrays, wind turbines, hydrodynamic and tidal turbines, wave energy converters, osmotic power modules, geothermal systems, and industrial waste-heat recovery systems. The invention provides techniques for using machine learning models to adjust operating setpoints of such assets in real time, predict degradation and failures, and coordinate dispatch across a fleet of assets.

In additional embodiments, the invention relates to digital representation, verification, and exchange of renewable energy and associated environmental attributes. The invention includes mechanisms for transforming AI-validated measurements of electrical energy produced by renewable assets into digital energy tokens recorded on a distributed ledger, executing smart contracts for peer-to-peer trading and revenue distribution, and minting carbon or environmental credit tokens tied to verified fossil fuel displacement.

In further embodiments, the invention addresses fleet-level coordination of geographically distributed renewable assets via federated learning, multi-modal dispatch optimization, and application programming interfaces (APIs) that expose energy production, token balances, and optimization recommendations to utilities, microgrid operators, asset managers, and other external systems.

Renewable energy deployment has expanded rapidly in recent years, driven by falling technology costs, policy incentives, and decarbonization goals. However, most existing installations are engineered and operated as modality-specific silos. A solar photovoltaic (PV) plant is typically provisioned with its own inverter controls and supervisory control and data acquisition (SCADA) system; a wind farm uses a separate turbine controller and SCADA environment; a small hydro plant, geothermal plant, or industrial waste-heat recovery system may each employ distinct control hardware, monitoring tools, and data schemas. This fragmentation makes it difficult to coordinate operation across heterogeneous assets, to reuse optimization logic, or to maintain a unified view of performance and risk at the portfolio level.

Conventional control strategies for renewable generation often rely on fixed rules, manually tuned feedback loops, and worst-case design assumptions. For example, PV plants may operate trackers according to simple sun-position algorithms and fixed wind-stow thresholds, regardless of evolving patterns of irradiance, cloud cover, soiling, or mechanical fatigue. Wind turbines may use static lookup tables for pitch and yaw control that are not continuously adapted to site-specific turbulence or aging drivetrain characteristics. Hydrodynamic and geothermal systems may run at fixed setpoints that do not fully exploit variations in resource conditions or downstream process interactions. As assets age and environmental conditions shift, these static strategies can lead to suboptimal energy yield, unnecessary curtailment, and accelerated wear.

At the same time, many distributed renewable assets lack robust mechanisms for monetizing their production beyond simple net metering or feed-in tariffs, where available. In numerous jurisdictions, smaller generators, behind-the-meter systems, and community microgrids are constrained by regulatory and infrastructural barriers that limit participation in wholesale markets or bilateral trading. Existing peer-to-peer energy trading proposals often rely on coarse-grained metering data or trust assumptions that are not tightly linked to high-frequency sensor telemetry and machine-validated operating conditions. This can result in limited trust, exposure to fraud or double counting, and difficulty in integrating such schemes with formal markets and regulatory reporting.

Some prior systems have proposed the use of distributed ledger technology or blockchain-based platforms for representing and trading energy units or renewable energy certificates. However, many such systems treat the ledger as an accounting overlay that is loosely coupled to physical generation. Tokens representing energy or certificates may be created based on manual reporting, periodic meter reads, or utility-supplied aggregates, without fine-grained linkage to real-time sensor data, equipment health, or compliance with operating envelopes. In addition, these systems often do not address multi-modal portfolios, advanced AI-based control, or privacy-preserving coordination across fleets.

Existing distributed energy resource management systems (DERMS) and microgrid controllers provide some capabilities for load and generation balancing, demand response, and limited storage coordination. Yet, these platforms typically target specific device classes or vendor ecosystems, lack integrated mechanisms for tokenizing and trading verified renewable output, and may not employ modern machine learning techniques such as reinforcement learning, anomaly detection, or federated learning. As a result, opportunities are missed to optimize across modalities, to continuously refine control policies based on observed performance, and to couple physical optimization with financial and environmental value streams.

There is therefore a need for an integrated system that (i) unifies control and optimization of diverse renewable energy modalities under a common AI and sensing fabric; (ii) validates and transforms fine-grained, sensor-backed measurements of renewable generation into digital tokens representing energy and associated environmental attributes; and (iii) enables decentralized, programmable markets for trading such tokens and allocating revenues in a transparent and auditable manner. There is a further need for such a system to support modular scaling from kilowatt-scale assets to multi-megawatt portfolios, to operate under intermittent connectivity, and to incorporate privacy-preserving fleet-level learning and coordination.

The present invention addresses the foregoing limitations by providing a unified architecture for AI-orchestrated multi-source renewable energy harvesting and decentralized energy trading. In one aspect, the invention provides an energy harvesting node that combines a modality-specific energy conversion module, a sensor array, an edge AI processing unit, and a power conversion subsystem. The node continuously acquires operating and environmental telemetry, predicts performance degradation and failure modes, and computes control actions that adjust operating setpoints to increase net energy yield while respecting component stress constraints. The conditioned electrical power is delivered to local storage, microgrids, or utility grids.

In another aspect, the invention provides a blockchain-based orchestration layer that receives validated summaries of electrical energy generated by a plurality of such nodes. One or more AI models verify that the energy was produced under predefined operating, safety, and environmental envelopes and aggregate the verified output into discrete energy quanta. For each quantum, the orchestration layer mints a digital energy token on a distributed ledger, the token including provenance metadata such as node identity, time interval, and modality type. The orchestration layer further executes smart contracts that implement peer-to-peer trading of the energy tokens, dynamic pricing rules informed by AI-derived forecasts and external market data, and programmable revenue-splitting logic among stakeholders.

In a further aspect, the invention provides a fleet-level AI coordination module that leverages federated learning and multi-modal dispatch optimization. Each node trains or updates local models using its own sensor data and periodically transmits model parameter updates or compressed gradients to the fleet-level module. The fleet-level module aggregates these updates to produce improved global models that are redistributed to nodes, enabling continuous improvement without centralizing raw telemetry. The fleet-level module can also compute portfolio-level dispatch and curtailment strategies across heterogeneous modalities and storage resources to improve overall efficiency, maintain grid constraints, and enhance trading liquidity.

In certain embodiments, the invention includes application programming interfaces that expose energy production data, health and optimization metrics, token balances, and trading information to external systems such as utilities, microgrid controllers, asset management platforms, billing systems, and regulatory reporting tools. These interfaces enable integration of the disclosed system into existing operational and financial workflows while preserving the benefits of AI-driven optimization and cryptographically verifiable energy accounting.

In various embodiments, the invention further comprises cybersecurity mechanisms and node attestation protocols that restrict token minting and control functions to authenticated and integrity-verified nodes. AI-based anomaly detection models can identify sensor spoofing, unrealistic generation patterns, or other signs of fraudulent or unsafe behavior, triggering suspension of tokenization or derating of affected assets. The combination of physical telemetry, edge and fleet AI, distributed ledger records, and programmable smart contracts provides a robust foundation for verifiable, economically efficient, and scalable deployment of multi-source renewable energy portfolios.

As used herein, the term “energy harvesting node” refers to a localized assembly of hardware and software configured to convert one or more renewable resources into electrical power, measure operating and environmental conditions, execute AI-based control logic, and interface with power conversion equipment. An energy harvesting node may include one or more energy harvesting modules, a sensor array, an AI processing unit, communications interfaces, and associated mounting and interconnection hardware.

The term “energy harvesting module” refers to the physical apparatus that directly converts a renewable resource into electrical energy, such as a solar photovoltaic (PV) string or array, a wind turbine, a run-of-river or tidal turbine, a wave energy converter, an osmotic power membrane assembly, a geothermal well and associated heat exchangers, or an industrial waste-heat recovery unit. An energy harvesting module may include mechanical structures, electrical generators, heat exchangers, fluid circuits, and other components specific to a modality.

The term “modality” refers to a class of renewable resource and corresponding conversion technology, including, without limitation, solar, wind, hydro, tidal, wave, osmotic, geothermal, and waste-heat modalities. A single deployment may include multiple modalities operating concurrently.

The term “sensor array” refers to a collection of one or more sensors embedded in or operatively coupled to an energy harvesting module or its environment. Sensors may include, by way of example, irradiance sensors, temperature sensors, wind speed and direction sensors, flow and pressure sensors, vibration and acceleration sensors, rotational speed sensors, voltage and current sensors, power factor sensors, and sensors that directly or indirectly indicate component degradation.

The term “AI processing unit” refers to a computing subsystem at or near an energy harvesting node that is configured to execute machine learning algorithms, control logic, and data processing functions. The AI processing unit may be implemented using a combination of central processing units (CPUs), graphics processing units (GPUs), tensor accelerators, neural processing units (NPUs), digital signal processors (DSPs), or other processors, and may run a real-time operating system or embedded software stack.

The term “power conversion subsystem” refers to a set of electrical components and control circuitry configured to condition raw electrical output from an energy harvesting module into a form suitable for delivery to energy storage devices, microgrids, or utility grids. The power conversion subsystem may include DC-DC converters, inverters, transformers, relays, filters, and protection devices, as well as associated firmware for implementing control strategies and grid support functions.

The term “validated energy quantum” refers to a discrete quantity of electrical energy produced by one or more energy harvesting nodes over a defined time interval, where the quantity and its associated attributes have been verified by AI models and rule-based checks to satisfy predefined operating, safety, and environmental constraints. Validation may include checking sensor integrity, comparing measured performance to expected ranges, and confirming compliance with regulatory or contractual limits.

The term “digital energy token” refers to a digital representation of a validated energy quantum recorded on a distributed ledger or functionally equivalent transaction log. A digital energy token includes metadata such as a node identifier, time interval, modality type, and energy quantity, and may be fungible or non-fungible depending on implementation. Digital energy tokens may be tradable among parties and may confer rights or claims related to energy delivery, revenue, or environmental attributes.

The term “blockchain orchestration layer” refers to a set of software and hardware components configured to maintain a distributed ledger, execute smart contracts, and coordinate token minting, trading, and settlement processes. The blockchain orchestration layer may be implemented using one or more blockchain networks, sidechains, or other distributed ledger technologies, and may interface with off-chain services such as oracles and analytic engines.

The term “smart contract” refers to program logic deployed on a distributed ledger platform that executes deterministically in response to transactions and state changes. In the context of the present invention, smart contracts may govern token minting, energy token trading, revenue distribution, subscription billing, carbon credit issuance, and governance functions.

The term “fleet-level AI coordination module” refers to a software component or collection of components that operate at a level above individual nodes to aggregate model updates, perform federated learning or other collaborative training methods, and compute dispatch and curtailment strategies for a portfolio of energy harvesting nodes. The fleet-level AI coordination module may reside in a cloud environment, at regional hubs, or across multiple cooperating servers.

The term “federated learning” refers to a family of machine learning techniques in which model training is distributed across multiple devices or nodes, each of which trains on its own local data and shares model updates or gradients with a coordinating entity. The coordinating entity aggregates the updates to form a global model, thereby improving performance without requiring raw data to leave the local nodes.

The term “microgrid” refers to a localized group of interconnected loads and distributed energy resources that can operate in connection with the main utility grid or in an islanded mode. A microgrid may be managed by a microgrid controller or energy management system that orchestrates generation, storage, and load.

The term “environmental credit token” or “carbon credit token” refers to a digital representation of an environmental attribute, such as avoided greenhouse gas emissions or renewable energy certificates, that is minted based on validated renewable energy production and recognized baseline emission factors. Such tokens may be used for compliance or voluntary reporting and may be traded or retired.

Unless otherwise indicated, the terms “comprised of,” “comprising,” “including,” and “having” are intended to be open-ended and to mean “including but not limited to.” The singular forms “a,” “an,” and “the” are intended to include the plural forms as well, unless the context clearly indicates otherwise. References to “one embodiment,” “an embodiment,” or “some embodiments” are intended to indicate that a particular feature, structure, or characteristic described in connection with the embodiment is included in at least one embodiment of the invention, and such phrases do not necessarily refer to the same embodiment.

In an overview embodiment, the system comprises three principal layers: (i) a plurality of energy harvesting nodes deployed at the physical sites of renewable resources, (ii) a fleet-level coordination and analytics layer that aggregates intelligence across nodes, and (iii) a blockchain orchestration and market layer that represents validated energy and environmental attributes as tradable digital tokens. These layers are interconnected via secure communication channels and exposed to external systems through one or more application programming interfaces.

Each energy harvesting node includes at least one energy harvesting module, a sensor array, an AI processing unit, a power conversion subsystem, and one or more communication interfaces. The energy harvesting module converts local renewable resources into electrical power. The sensor array acquires real-time telemetry from mechanical, electrical, and environmental subsystems. The AI processing unit executes control and diagnostic logic based on the telemetry and communicates setpoints to actuators and power electronic controllers. The power conversion subsystem conditions the harvested power for delivery to local loads, storage, microgrids, or utility grids.

The fleet-level coordination and analytics layer comprises one or more servers or cloud services that receive periodic summaries of node performance, health metrics, and model updates. This layer includes the fleet-level AI coordination module, which orchestrates federated learning rounds, aggregates model parameters or compressed gradients from nodes, and disseminates improved model versions back to nodes. It may also execute portfolio-level optimization routines that determine recommended dispatch and curtailment patterns across the fleet, taking into account forecasted resource availability, load, grid constraints, and market conditions.

The blockchain orchestration layer comprises validator nodes, ledger storage, and smart contract execution environments. This layer receives validated energy summaries and associated proofs from energy harvesting nodes or from the fleet-level coordination layer. Based on predefined rules and AI validation results, the orchestration layer mints digital energy tokens representing discrete validated energy quanta, records trades and settlements, and mints environmental credit tokens when appropriate. Smart contracts deployed on this layer implement market mechanisms and revenue allocation logic.

Communication between energy harvesting nodes and the fleet-level coordination layer may occur over wired or wireless networks, including but not limited to Ethernet, fiber, cellular networks, satellite links, and low-power wide-area networks. Communications may use industrial protocols, message queues, or web-based APIs. Nodes can buffer telemetry and control logs locally to tolerate intermittent connectivity and upload data in batches when connectivity is restored.

Communication between energy harvesting nodes and the blockchain orchestration layer can be direct or mediated by gateway devices. In some embodiments, nodes send compact, signed summaries of energy production and validation results to gateway servers that aggregate and submit transactions to the distributed ledger. Gateways may perform additional checks, such as verifying node attestations or enforcing regional policies, before relaying data to the ledger network.

The system further comprises external integration interfaces that expose data and control surfaces to utilities, microgrid controllers, asset management systems, billing platforms, and regulatory reporting tools. These interfaces may provide access to near-real-time and historical production data, asset health indicators, token balances, trade histories, emissions reductions, and AI-derived optimization recommendations. Authentication and authorization controls restrict access according to tenant boundaries, roles, and regulatory requirements.

In some embodiments, a management and configuration subsystem spans the three principal layers. This subsystem includes tools for commissioning and configuring new nodes, deploying and rolling back AI models and control policies, managing cryptographic keys and certificates, and defining market and tokenization parameters. Configuration changes may be versioned and logged in the ledger or in associated audit logs, enabling traceability of operational decisions.

The architecture supports modular deployment. A minimal deployment may consist of a single energy harvesting node running local AI optimization without participation in tokenization or trading. A more complete deployment may include multiple nodes connected to a fleet-level coordinator but using a centralized or off-chain ledger. A fully featured deployment connects nodes, fleet-level AI, and blockchain orchestration, enabling AI-optimized harvesting, verifiable tokenization, decentralized trading, and comprehensive analytics across a geographically distributed, multi-modal renewable portfolio.

The described system-level architecture provides a common pattern for subsequent detailed embodiments. Variants may adjust the placement of specific components, the degree of centralization, and the technologies used for ledger and AI implementation, while maintaining the core structure of node-level AI-orchestrated energy harvesting, fleet-level learning and coordination, and cryptographically verifiable digital representation and exchange of renewable energy value.

In a general embodiment, an energy harvesting node comprises a mounting structure or housing that supports the energy harvesting module, sensor array, power electronics, and AI processing unit in proximity to the renewable resource. The node may be located outdoors or indoors depending on modality and application. Environmental protection features such as enclosures with ingress protection ratings, thermal management elements, and lightning protection may be included to ensure reliable operation in harsh conditions.

The sensor array may be distributed across mechanical and electrical subsystems of the energy harvesting module. Environmental sensors can be mounted on or near the module to measure ambient temperature, irradiance, wind speed and direction, precipitation, or water level. Mechanical sensors may include accelerometers, strain gauges, displacement sensors, and vibration sensors attached to structures such as turbine towers, blades, tracker frames, or heat-exchanger mounts. Electrical sensors may measure voltages, currents, power factor, harmonics, and other power quality indicators at one or more points between the generator and the point of interconnection.

The AI processing unit can be physically located in a junction box, control cabinet, or dedicated control room associated with the node. In some embodiments, the AI processing unit is implemented on an industrial-grade computing platform that supports extended temperature ranges, vibration tolerance, and redundant storage. The AI processing unit may execute a software stack including device drivers, a real-time or general-purpose operating system, AI inference engines, and application logic for control and communication.

Local communications within the node may be provided by one or more field buses or industrial communication protocols, such as Modbus, CAN, PROFIBUS, EtherCAT, or similar technologies. These internal networks connect sensors, actuators, power electronic controllers, and the AI processing unit. The AI processing unit polls or subscribes to sensor data and publishes control commands or setpoints at variable intervals depending on the dynamics of the controlled subsystems.

The power conversion subsystem may be partitioned into multiple stages. For example, in a PV-based node, DC string voltages are aggregated in a combiner box and fed into DC-DC converters or string inverters that implement maximum power point tracking. In a wind-based node, generator output may be rectified and conditioned through converters that manage torque and rotor speed. In hydro and geothermal nodes, generator or alternator outputs may be stepped up or down by transformers and regulated by synchronous or static compensators. In all cases, the power conversion subsystem is instrumented by the sensor array and is controllable by the AI processing unit through adjustable parameters such as reference voltages, current limits, reactive power setpoints, and protection thresholds.

The AI processing unit executes one or more control loops that run at different frequencies. Fast loops may be associated with power electronic controllers and may remain implemented in dedicated controller hardware or firmware, while slower supervisory loops execute in the AI processing unit and adjust setpoints or mode parameters of the fast loops. For instance, the AI processing unit may periodically update target power factors, ramp rate limits, or tracker orientation trajectories based on forecasts and health assessments, while leaving low-level inverter switching to dedicated controllers.

In many embodiments, the AI processing unit maintains a local time series database or buffer that records sensor telemetry, control actions, and status flags. This local data store enables retrospective analysis, training of local models, and reconstruction of events in case of incidents or audits. The buffer may be periodically compressed, summarized, and transmitted to fleet-level coordination or off-site storage according to bandwidth and retention policies.

The node may include one or more communication interfaces for external connectivity, such as Ethernet, fiber, cellular modems, Wi-Fi, or long-range radio. Communication modules may support redundant paths to increase reliability. Security features such as virtual private networks, firewalls, intrusion detection, and encryption at rest and in transit may be implemented at the node to protect control and data paths from unauthorized access.

In some embodiments, the AI processing unit is configured to operate under different connectivity profiles. When connectivity to external systems is available, the AI unit may fetch model updates, configuration changes, or external signals such as price forecasts or grid requests. When connectivity is degraded or absent, the AI unit may fall back to locally stored models and policies, prioritizing safe and conservative operation while continuing to log telemetry for later synchronization.

The node's control software may implement a state machine defining operating modes such as normal operation, start-up, shut-down, maintenance, fault, islanded operation, and black-start. Transitions between states may be governed by sensor thresholds, external commands, and AI inferences. For example, detection of abnormal vibration patterns may trigger a transition from normal operation to derated or maintenance-required states, with associated control adjustments and notifications.

In some embodiments, safety-critical functions remain implemented in deterministic controllers or protection relays that are independent of the AI processing unit. Overcurrent, overvoltage, frequency, and ground fault protection may be executed in dedicated hardware that trips breakers or contactors regardless of AI behavior. The AI processing unit may monitor these protective devices and incorporate their status into optimization decisions, but cannot override their basic protective logic.

The energy harvesting node may support modular expansion. Additional energy harvesting modules, sensor channels, or power conversion units can be added to the node through standardized mechanical and electrical interfaces. The AI processing unit can automatically discover newly attached modules or be configured via commissioning tools to recognize and manage them. This modularity allows scaling of capacity at a site without complete redesign of the control architecture.

In further embodiments, the node includes a human-machine interface (HMI) such as a local display, control panel, or web-based dashboard accessible on-site. The HMI can present status indicators, alarms, AI-derived health metrics, control modes, and manual override options for authorized personnel. Operators may use the HMI during commissioning, troubleshooting, and maintenance procedures to view detailed telemetry and control traces.

Power and communication wiring within the node may be organized into segregated pathways for safety and electromagnetic compatibility. Shielding, grounding, and surge protection measures can be implemented to reduce noise and transient disturbances that might otherwise compromise sensor readings or digital communications. The physical layout of the node may be optimized to minimize cable lengths for sensitive signals and to facilitate maintenance access.

The generic node architecture described herein serves as a foundation for modality-specific embodiments, in which the type of energy harvesting module, sensor selection, actuator configuration, and AI control strategies are adapted to the physical characteristics and operational requirements of the underlying renewable resource. The following paragraphs describe representative modality-specific node configurations that illustrate how the general architecture can be instantiated for solar, wind, hydrodynamic, geothermal, and waste-heat applications.

In a solar photovoltaic embodiment, the energy harvesting module comprises one or more PV strings or arrays mounted on fixed-tilt structures or on single- or dual-axis trackers. Tracker structures include actuators such as linear actuators or rotary drives, along with position encoders and mechanical stops. The sensor array for the solar node may include pyranometers or reference cells measuring plane-of-array irradiance, back-of-module temperature sensors, ambient temperature and humidity sensors, wind speed and direction sensors, and DC voltage and current sensors at string, combiner, and inverter inputs. The AI processing unit receives these measurements and controls tracker orientation, inverter setpoints, and, where applicable, curtailment levels.

The AI control strategy for the solar node may include dynamic tracker optimization that considers not only instantaneous sun position but also predicted cloud cover, soiling levels, and mechanical fatigue. For example, the AI processing unit may learn site-specific relationships between tracker motion patterns, wind conditions, and mechanical wear, and may select orientation trajectories that maximize lifetime energy yield rather than instantaneous power alone. In some embodiments, the AI processing unit can predict soiling accumulation from declining performance relative to expected power curves or from dedicated soiling sensors, and can adjust cleaning schedules or tilt angles to mitigate losses.

In a wind turbine embodiment, the energy harvesting module comprises a horizontal-axis turbine with blades, hub, nacelle, tower, and generator. The sensor array may include cup or ultrasonic anemometers, wind vanes, nacelle and tower accelerometers, strain gauges, shaft torque sensors, oil temperature and pressure sensors, bearing temperature sensors, and electrical sensors for generator and converter outputs. The AI processing unit interfaces with the turbine's supervisory controller to influence blade pitch, yaw alignment, start and stop thresholds, and derating commands.

The wind turbine AI controller may maintain a learned baseline of power curve performance and vibration signatures under varying wind speeds and directions. Deviations from expected patterns can indicate icing, erosion, imbalance, blade damage, misalignment, or drivetrain issues. Based on these inferences, the AI processing unit can schedule inspections, recommend maintenance actions, or adjust operating setpoints to limit stress, such as by operating at reduced power in turbulent regimes or by adjusting yaw to minimize asymmetric loading. Gust-responsive pitch control may be implemented by predicting gusts from short-term wind data and adjusting pitch preemptively to avoid excessive loads.

In a hydrodynamic or osmotic power embodiment, the energy harvesting module may comprise run-of-river turbines, tidal turbines, wave energy converters, or salinity gradient power devices. Sensors may measure water levels, flow velocities, pressures across turbines or membranes, wave heights and periods, salinity levels, and mechanical loads on structures. The AI processing unit can adjust gate openings, blade pitch, turbine submergence, or membrane operating pressures in response to tidal cycles, seasonal flow variations, sediment loads, and biofouling indicators.

For tidal installations, the AI processing unit can learn site-specific relationships between predicted tidal currents and actual performance, enabling optimized scheduling of turbine operation and maintenance windows. In run-of-river systems, the AI processing unit may coordinate with upstream and downstream control structures to maintain environmental flow requirements while maximizing net generation. In wave energy systems, control policies can be tuned to incoming wave spectra to maximize energy capture without exceeding design loads.

In a geothermal or industrial waste-heat recovery embodiment, the energy harvesting module includes one or more heat exchangers, pumps, valves, and a thermodynamic cycle such as an Organic Rankine Cycle (ORC) or Kalina cycle. Sensors monitor temperatures at multiple points in the hot and cold loops, mass flow rates of working fluids, pump and fan power consumption, and generated electrical output. The AI processing unit can adjust working-fluid flow rates, pump speeds, expansion valve positions, and target temperatures to optimize cycle efficiency while maintaining safe equipment operation and respecting upstream process needs.

In an industrial waste-heat context, the AI processing unit may additionally monitor process variables and constraints from the host facility, such as production rates, critical equipment temperatures, and safety margins. Based on these inputs, the AI controller can throttle waste-heat extraction, switch between operating modes, or temporarily curtail energy harvesting to avoid impacting core industrial processes. Over time, the AI models can learn patterns in waste-heat availability and process flexibility to improve planning and scheduling of energy recovery.

In some embodiments, a single site may host multiple modalities, such as a hybrid plant combining solar PV, wind turbines, and battery storage, or an industrial campus combining rooftop PV, waste-heat recovery, and backup generators. In such configurations, individual energy harvesting nodes may be instantiated per modality, with their AI processing units coordinating locally while also participating in fleet-level dispatch optimization. Site-level controllers may aggregate recommendations from node-level AI and from the fleet-level coordination module to implement unified control strategies.

Each modality-specific node may expose a standardized interface describing its controllable parameters, constraints, and cost or degradation models. This abstraction allows the fleet-level coordination module to treat diverse assets as instances of a common dispatchable resource model, while still respecting modality-specific limitations and behaviors. For example, the abstract interface may represent each node by a power-versus-cost curve, ramp rate limits, state-of-health indicators, and availability windows, derived internally by the node's AI from richer telemetry.

Modality-specific embodiments can also account for site and equipment variations within the same modality. For example, a solar node configuration may be adapted for rooftop installations with partial shading and limited structural load capacity, versus ground-mounted utility-scale trackers in open fields. The AI models and control policies deployed to each node can be tailored to its mechanical tolerances, climatic conditions, and grid connection characteristics, while still adhering to the same overarching architecture and tokenization mechanisms.

In all modality-specific configurations, the AI processing unit is configured to operate within safety constraints imposed by equipment manufacturers, standards, and regulatory requirements. These constraints may be encoded as hard limits that the AI controller cannot override, such as maximum allowable temperatures, vibration levels, or electrical ratings. The AI control strategies thus optimize within feasible regions defined by both physical limits and policy constraints, ensuring that added intelligence does not compromise safety or compliance.

Although the examples presented focus on widely deployed renewable and waste-heat modalities, additional or future energy harvesting technologies may be integrated into the same architecture by implementing appropriate energy harvesting modules, sensor arrays, control interfaces, and AI models. The invention is not limited to the specific modalities described, and the generalized node architecture and fleet coordination mechanisms are intended to apply to any energy harvesting technology that can benefit from AI-optimized control and verifiable tokenization of energy output.

The sensor telemetry collected at each energy harvesting node serves multiple purposes, including real-time control, safety monitoring, predictive maintenance, performance benchmarking, and verification of energy production for tokenization. To support these functions, the sensor array and data acquisition pipeline are designed to capture both fast-changing signals and slower trends. Sampling rates may be modality-dependent, with electrical and vibration measurements sampled at higher frequencies than environmental or structural parameters, while aggregation layers compute derived metrics over sliding windows.

Raw telemetry is preprocessed at the node by the AI processing unit or an associated data acquisition module. Preprocessing steps may include filtering to remove noise, resampling to uniform time bases, detection and handling of missing or out-of-range values, and transformation into domain-specific features such as moving averages, variances, spectral components, or residuals relative to expected baselines. These derived features are used as inputs to machine learning models that estimate health, performance, and risk.

Predictive maintenance capabilities are enabled by models that map time series of sensor features to health indicators and remaining useful life estimates for critical components. For instance, in a wind turbine node, models may track changes in vibration spectra at specific frequencies associated with bearings or gear mesh, combined with load and temperature histories, to estimate the probability and timing of failures. In a PV node, models may track string-level power deviations, module temperatures, and irradiance to detect hotspots, encapsulant browning, or connector degradation.

Health indicators may be expressed as scalar scores, categorical states (such as “healthy,” “monitor,” “maintenance recommended,” or “faulted”), or probability distributions over failure modes. The AI processing unit can expose these indicators via local HMIs and via fleet-level reporting interfaces. Thresholds for alarms or automatic derating can be configured based on risk tolerance, manufacturer recommendations, or regulatory limits, and may be adjusted over time as more data becomes available.

The system may maintain digital histories for each component or subassembly, sometimes referred to as “component passports” or “lifecycle records.” These records store time-stamped health indicators, maintenance actions, replacements, and anomalies detected over the component's operational life. When a component is replaced, its history can be closed and associated with decommissioning data, while a new record is created for the replacement. Aggregated component histories support fleet-wide reliability analysis and model calibration.

Anomaly detection models can complement predictive maintenance by flagging unexpected patterns in the data that may not match known failure signatures. Unsupervised or semi-supervised learning methods, such as autoencoders or clustering-based detectors, can be trained on historical data representing normal operation. Deviations from learned normal patterns—such as unusual combinations of temperature, vibration, and power—can trigger alerts or initiate deeper diagnostic routines.

In some embodiments, health and anomaly models are structured hierarchically. Low-level models may operate at the sensor or subcomponent level, while higher-level models combine their outputs to assess overall node health and risk. For example, multiple minor anomalies in different subsystems may collectively indicate increased likelihood of a system-level incident, even if each alone is within acceptable ranges. The AI processing unit can aggregate these signals into composite risk scores used in control and scheduling decisions.

Telemetry and health metrics play a direct role in the validation of energy output for tokenization. Validation logic may require that, during a given quantization interval, key sensors were operational and within calibration; that health indicators did not signal critical faults; that operating conditions were consistent with claimed energy production; and that no anomalies indicating tampering or misreporting were present. Failure to meet these conditions can result in withholding or downgrading of token issuance for that interval.

To support robust validation, the system may compute “consistency checks” that compare independent measurements or cross-validate physical relationships. For example, measured power can be compared against expected power given irradiance and temperature in a PV node, or against expected torque-speed relationships in a wind turbine. Significant discrepancies may indicate sensor faults, wiring issues, or fraudulent injection of data. Cross-checks may also compare energy reported at different points, such as between generator and point of interconnection, accounting for losses.

The AI processing unit may maintain calibration profiles and drift models for sensors. Over time, sensors can drift due to aging, contamination, or mechanical changes. The system can detect drift by comparing sensor outputs to reference sensors, redundant channels, or derived estimates from physical models. When drift exceeds thresholds, the system may adjust sensor calibration in software, flag sensors for replacement, or adjust confidence weights used in validation and control.

In addition to health-focused models, performance benchmarking models can be employed to assess how well each node or asset is performing relative to its theoretical or peer-based potential. Benchmarking may use normalized performance ratios, yield comparisons across similar assets, and adjustments for resource availability and aging. Persistent underperformance can trigger targeted diagnostics and optimization efforts, while high-performing assets may be used as reference cases for model training and best-practice identification.

The predictive maintenance and telemetry framework also supports optimization of maintenance scheduling and resource allocation. Using remaining useful life estimates, failure probabilities, and cost models, the system can cluster maintenance tasks across multiple nodes to minimize downtime and logistics costs. For example, assets in the same geographic area with similar predicted maintenance windows can be grouped into shared service visits. The system can also recommend opportunistic maintenance during periods of low energy prices or poor resource conditions.

In some embodiments, telemetry relevant to safety and compliance is retained for extended periods or indefinitely, subject to storage policies and regulations. This may include logs of trips and faults, safety-related alarms, override actions, and any incidents affecting personnel or equipment. These records can be referenced in incident investigations, regulatory audits, insurance claims, and continuous improvement programs. Aggregated across fleets, they can inform updates to standards and best practices.

The telemetry and predictive maintenance capabilities are designed to function even in the presence of intermittent connectivity. Local storage and processing ensure that health monitoring and safety-related logic remain effective even when remote communication is unavailable. Upon reconnection, buffered telemetry and health summaries can be uploaded to fleet-level systems for centralized analysis and long-term archiving, ensuring that no gaps appear in lifecycle records.

While specific sensor types, models, and analytical techniques may vary by implementation, the essential role of the telemetry and predictive maintenance subsystem within the invention is to supply high-quality, AI-interpreted data that simultaneously improves operational performance, reduces lifecycle costs, and underpins trustworthy tokenization of renewable energy production. This tight coupling between physical monitoring and digital representation distinguishes the disclosed system from prior approaches that treat monitoring and market representation as separate concerns.

The AI control logic at each energy harvesting node may include a combination of model-based and data-driven components. In one embodiment, the AI processing unit hosts pre-trained machine learning models that map sensor features and operating context to recommended control actions. These models may be derived from supervised learning on historical operation data, physics-informed neural networks, or hybrid models that embed physical constraints into data-driven architectures. In another embodiment, the AI processing unit hosts reinforcement learning (RL) agents that have been trained in simulation and are fine-tuned on real-world data under safety constraints.

Supervised models can be used to predict quantities such as next-interval power output under candidate control actions, expected component stress indices, or probabilities of violating grid or equipment constraints. Given these predictions, an optimization module can solve a local control problem that maximizes a reward function or objective subject to constraints. For example, the objective may be to maximize net energy yield minus weighted degradation cost, with constraints on voltage, frequency, thermal limits, and ramp rates. The optimization module may be implemented using linear, quadratic, or non-linear programming techniques depending on problem structure.

Reinforcement learning agents, where employed, can learn control policies by interacting with a simulated environment representing the energy harvesting node and its surroundings. The environment may incorporate physical models of the energy conversion process, grid or microgrid dynamics, and stochastic models of resource availability and loads. During training, the RL agent receives observations derived from simulated sensor data and selects actions corresponding to control setpoints or mode selections. The environment returns rewards based on energy yield, equipment stress, and other objectives, and the agent updates its policy to improve long-term cumulative reward.

To safely deploy RL-derived policies in the physical system, the invention may use a two-stage approach. First, candidate policies are trained and evaluated entirely in simulation, including stress-testing under rare or extreme scenarios. Second, selected policies are transferred to the physical AI processing unit and initially run in a shadow or advisory mode, where they generate recommended actions without directly controlling equipment. The recommendations are compared to baseline or rule-based control outputs, and discrepancies are analyzed. Only after sufficient validation and tuning are policies allowed to influence control actions, and even then within bounds enforced by safety supervisors.

The reward function for RL agents or for optimization objectives may include multiple terms representing different goals. A primary term may be proportional to net kilowatt-hours exported over a time horizon. Secondary terms may penalize mechanical fatigue (for example, using cumulative damage metrics derived from rainflow counting of stress cycles), penalize operation near thermal or electrical limits, reward smooth power output, or reward compliance with grid support requests such as frequency regulation or reactive power provisioning. Weights on these terms can be configured or adaptively tuned based on asset owner preferences, contractual obligations, and regulatory requirements.

In some embodiments, the AI processing unit supports hybrid control architectures in which AI-based controllers operate in conjunction with conventional controllers. A conventional controller may maintain fundamental stability and enforce hard constraints, while the AI-based controller introduces bias terms or reference adjustments within safe envelopes. For example, a standard maximum power point tracking (MPPT) algorithm in an inverter may be retained, while the AI controller adjusts power caps or ramp rate limits. Similarly, in a wind turbine, a standard pitch control algorithm may remain primary, while the AI controller modifies target power or pitch offsets to reduce fatigue under certain conditions.

The AI control stack may be organized into layers, including a fast inner loop, a medium-speed supervisory loop, and a slower planning loop. The fast inner loop resides in dedicated control hardware or real-time software and handles millisecond-level dynamics. The supervisory loop, executing on the AI processing unit at intervals from sub-second to tens of seconds, updates setpoints and modes based on short-term forecasts and health metrics. The planning loop, executing at intervals from minutes to hours, considers longer-term forecasts, pricing signals, and maintenance schedules to adjust operating strategies, such as pre-charging storage before high-price periods or derating during anticipated high-stress events.

AI models deployed to nodes are versioned and managed by the fleet-level coordination and configuration subsystems. Each model version is associated with metadata describing its training data window, architecture, hyperparameters, performance metrics, and validation results. When a new model version is deployed to a node, the node may run the new model in parallel with the prior version for a transition period, comparing outputs and logging differences. If the new model behaves as expected, it may be promoted to primary control; otherwise, it may be rolled back.

The AI processing unit may also host diagnostic models that explain or interpret control decisions. For example, feature attribution techniques may be used to identify which sensor features most strongly influenced a particular control adjustment or anomaly detection. These explanations can be logged and made available to operators, auditors, or regulators to enhance transparency and trust in AI-driven control. Explanations may also be used to debug models and refine training data.

To accommodate variations in node hardware and local conditions, the AI control logic can be parameterized or conditioned on node-specific attributes. Such attributes may include equipment capacity, mechanical tolerances, local climate classification, grid connection type, and regulatory constraints. Models may accept these attributes as inputs or select among specialized model variants tailored to different classes of nodes. This approach enables a single model family to generalize across heterogeneous assets while still capturing important local nuances.

In some embodiments, the AI processing unit may run on a schedule that combines periodic control updates with event-driven responses. Periodic updates handle regular adjustments based on slowly varying conditions, while event-driven triggers respond to specific signals such as grid frequency excursions, fault detections, or sudden changes in resource conditions. Event-driven responses may temporarily override or augment periodic control, for instance by rapidly curtailing output or switching modes during a grid disturbance.

The system may include guardrails that bound the magnitude and rate of change of AI-generated control adjustments. These guardrails prevent overly aggressive changes that could destabilize equipment, violate grid codes, or surprise human operators. Guardrails may be expressed as constraints on control signals, as maximum deviations from baseline settings, or as budgets on cumulative control adjustments over time. Violations of guardrails can trigger alarms and fallback to conservative control policies.

The AI processing unit may also support simulation and “what-if” analysis at the node level. Operators can input hypothetical control policies, environmental conditions, or pricing scenarios and evaluate predicted impacts on energy production, component stress, and revenue. These simulations can be used to evaluate policy changes before deployment, to plan maintenance windows, or to assess the value of upgrades such as additional sensors, improved trackers, or storage additions.

Over time, the AI control logic is expected to evolve as more data is collected and as models are refined through federated learning and centralized analysis. The system architecture supports this evolution by decoupling control interfaces from specific model implementations, by maintaining backwards compatibility in control and sensor schemas, and by maintaining detailed logs of model versions and control decisions. This ensures that improvements in AI algorithms can be deployed without requiring wholesale replacement of field hardware.

While specific AI techniques and algorithms may vary by implementation and over time, the role of the AI control subsystem within the invention is to leverage rich, high-frequency telemetry and learned models to make more informed, context-aware control decisions than static or rule-based controllers, and to do so in a manner that respects safety constraints and integrates with tokenization and trading functions. This combination of edge AI control, lifecycle learning, and digital market integration differentiates the disclosed system from conventional renewable energy controllers.

The power conversion subsystem of each energy harvesting node is responsible for transforming raw electrical output from the energy harvesting module into one or more forms suitable for delivery to local loads, energy storage devices, microgrids, or utility grids. In a general embodiment, the power conversion subsystem comprises at least one stage of DC-DC conversion, at least one inverter stage for conversion between direct current and alternating current, and one or more protective and switching devices such as breakers, relays, contactors, and fuses. The subsystem may further include transformers, filters, and measurement circuits required to meet applicable interconnection standards and power quality requirements.

In a PV-based node, the power conversion subsystem may employ string inverters, central inverters, or module-level power electronics such as DC optimizers. Maximum power point tracking (MPPT) algorithms may be implemented within the inverter firmware to extract maximum available power from the PV array under prevailing irradiance and temperature conditions. The AI processing unit can influence the operation of MPPT controllers by adjusting power limits, ramp rates, or curtailment levels, for example in response to grid requests or to manage thermal stress on inverters and modules.

For wind turbines, the power conversion subsystem may include rectifiers and converters that control generator torque and rotor speed, enabling variable-speed operation. In doubly fed induction generator (DFIG) configurations, power electronic converters may connect the rotor to the grid, while the stator is directly connected. In full-converter configurations, the generator output is fully rectified and inverted. The AI processing unit may adjust converter setpoints, such as reactive power targets or damping settings, to provide voltage support, frequency support, or oscillation damping, while ensuring that current and voltage remain within safe limits.

In hydrodynamic and geothermal nodes, the power conversion subsystem may comprise synchronous generators, induction generators, or permanent magnet machines connected through excitation systems, rectifiers, and inverters. Transformers and tap changers may be included to match generator voltages to grid or microgrid voltages. The AI processing unit may coordinate generator excitation, voltage setpoints, and reactive power flows to maintain voltage within prescribed ranges at the point of interconnection, and to support grid codes related to low-voltage ride-through, fault contributions, and frequency response.

Energy storage devices, such as batteries, supercapacitors, flywheels, or thermal storage systems, may be integrated with the power conversion subsystem to provide buffering, peak shaving, and ancillary services. Storage interfaces can include bidirectional converters that allow charging and discharging under AI supervision. The AI processing unit may schedule storage usage based on forecasts of renewable production, load, market prices, and grid conditions, as well as storage health metrics such as state-of-charge, state-of-health, and cycle counts.

The power conversion subsystem may be designed to support multiple modes of operation, including grid-tied, islanded, and black-start modes. In grid-tied mode, the subsystem synchronizes with grid voltage and frequency, injects power according to setpoints, and responds to grid disturbances according to interconnection requirements. In islanded mode, the subsystem may assume primary responsibility for voltage and frequency regulation within a microgrid, coordinating with other distributed energy resources as needed. In black-start mode, the subsystem may energize local loads and gradually build up a microgrid from a de-energized state, potentially coordinating with generators and storage to restore service.

Mode transitions can be managed by the AI processing unit in conjunction with dedicated microgrid or grid-forming controllers. For example, upon detection of a grid outage, the system may transition from grid-tied to islanded mode, reconfigure protection settings, and adjust control strategies to maintain local stability. When grid service is restored, the system may resynchronize phase, frequency, and voltage before reclosing interconnection devices. The AI processing unit may aid in these transitions by analyzing grid quality, load requirements, and asset readiness.

Protection and safety within the power conversion subsystem are ensured by a combination of hardware and software mechanisms. Hardware protection may include overcurrent and short-circuit protection, over/under-voltage and over/under-frequency relays, ground fault detection, and anti-islanding protection. Software and AI layers may monitor protective device operations, log events, and incorporate protection status into optimization logic, but do not override fundamental protective actions. In some embodiments, the AI processing unit can recommend changes to protection settings (for example, to accommodate new assets or grid code updates), but such changes may require explicit human approval.

Power quality management is another function of the power conversion subsystem.

Harmonics, flicker, unbalance, and transients can be monitored by sensors at key points in the electrical network. The AI processing unit can adjust inverter switching strategies, filter configurations, and reactive power flows to mitigate power quality issues. In multi-node deployments, fleet-level coordination can distribute reactive support and harmonic mitigation tasks to nodes best positioned to address issues, for example based on topology and capacity.

Communication between the AI processing unit and the power conversion subsystem may use standardized communication protocols, such as SunSpec Modbus for PV inverters, IEC 61850 for substation and DER communication, or vendor-specific APIs. The AI processing unit can read status registers, write control registers, and issue commands consistent with these protocols. Abstraction layers within the AI firmware may normalize device-specific differences into a common control interface used by optimization algorithms.

In some embodiments, the power conversion subsystem supports grid services such as frequency regulation, voltage regulation, spinning reserve, or inertia emulation. The AI processing unit can interface with grid operator signals, such as automatic generation control (AGC) setpoints or frequency response programs, and translate them into control actions at the node. Tokenization mechanisms may account for the provision of such services, allowing separate compensation streams for energy, capacity, and ancillary services to be represented and traded via digital tokens.

The design of the power conversion subsystem and its integration with AI control and tokenization logic ensures that the physical act of delivering electrical energy to loads and grids is coherently linked to digital representations of that energy. Because conversion stages, modes, and protective actions are monitored and, where appropriate, influenced by AI, the system can provide high-resolution, trustworthy records of when, how, and under what conditions energy was delivered, which in turn underpins the integrity of the digital energy tokens and associated environmental credits.

At the portfolio scale, a fleet-level AI coordination module integrates information from multiple energy harvesting nodes to improve model quality, coordinate dispatch, and enhance grid and market interactions. In one embodiment, each node periodically transmits summaries of local models, performance metrics, and contextual information—such as resource forecasts, load forecasts, and grid constraints—to the fleet-level module. These summaries are compact and may exclude raw high-frequency telemetry, thereby reducing bandwidth requirements and preserving data privacy.

The fleet-level AI coordination module orchestrates federated learning across the fleet. In a typical federated learning round, the module specifies a global model version, training objectives, and hyperparameters, and sends them to participating nodes. Each node trains or updates the model locally using its own data, for example by running a limited number of gradient descent steps on recent telemetry. The nodes then send back model updates or compressed gradient information, which may be further protected by differential privacy techniques or secure aggregation protocols.

The coordination module aggregates the received updates to produce an improved global model. Aggregation algorithms can include simple federated averaging, weighted averaging based on node data volumes or reliability scores, or robust aggregation methods that down-weight outliers and potentially malicious updates. The aggregated model is evaluated against validation datasets, which may include held-out data from representative nodes or synthetic benchmark scenarios. If validation results meet predefined criteria, the updated model is versioned and redistributed; otherwise, the module may adjust aggregation parameters, exclude suspect updates, or initiate another training round.

Federated learning may be applied to multiple model types, including forecasting models for renewable production, load, or prices; anomaly detection models; predictive maintenance models; and control policy models. For example, PV nodes in different climates and orientations can collectively improve a shared irradiance-to-power forecasting model, while wind nodes can improve turbine-specific health models under diverse turbulence regimes. By leveraging diversity across the fleet, the system accelerates learning and achieves higher robustness than would be possible with isolated, site-specific training.

The fleet-level coordination module also performs multi-modal dispatch and curtailment optimization. Given forecasts of resource availability, load, grid constraints, and market prices, the module computes recommended power schedules for each node or group of nodes over planning horizons ranging from minutes to days. The optimization problem may be formulated as a mixed-integer linear or non-linear program that seeks to minimize levelized cost of energy, maximize revenue, or achieve environmental or reliability targets, subject to operational constraints such as ramp rates, capacity limits, state-of-charge dynamics for storage, and network constraints such as line limits.

Dispatch recommendations can be communicated back to nodes as time series of target setpoints, ramp rate profiles, or cost signals. Nodes may implement these recommendations exactly or may adapt them based on local conditions and constraints, such as unexpected equipment issues or microgrid requirements. In some embodiments, dispatch optimization is hierarchical: a top-level optimizer sets high-level targets for each region or modality, while local optimizers refine targets within finer-grained constraints.

The fleet-level coordinator can also interface with grid operators and market platforms. For example, it may aggregate capabilities from multiple nodes to bid into ancillary services markets or capacity markets. It can compute composite offers that reflect fleet flexibility and reliability, submit bids via appropriate interfaces, and, upon acceptance, allocate obligations to individual nodes. Fulfillment of these obligations, such as maintaining specified up or down reserves or providing frequency response, can be tracked and verified using both node telemetry and on-chain records.

In some embodiments, the coordinator maintains region-specific sub-models and optimization instances. Nodes are grouped into regions based on electrical connectivity, jurisdiction, or market zone. Each region may have its own grid constraints, regulatory rules, and price signals. The coordinator runs separate optimization problems for each region, with limited coupling between regions, for example via intertie capacities or aggregate balancing requirements. This regionalization improves scalability and aligns with how many power systems and markets are organized.

The coordination module may compute and maintain risk and reliability metrics at the fleet level. Such metrics may include aggregate probability of supply shortfalls, expected unserved energy, asset health distributions, and exposure to extreme events such as storms or heat waves. These metrics can inform risk-adjusted dispatch strategies, insurance arrangements, and investment decisions. They may also be represented in digital form via specialized tokens or indicators recorded on the ledger for use by investors and regulators.

To support policy and planning, the fleet-level coordinator may implement scenario analysis capabilities. Users can define scenarios involving changes in resource profiles, asset configurations, market prices, regulatory frameworks, or control policies. The coordinator simulates fleet behavior under these scenarios using models and optimization routines, producing outputs such as energy production distributions, financial outcomes, emissions trajectories, and reliability metrics. These analyses can inform decisions about adding or retiring assets, upgrading equipment, or modifying operating strategies.

The coordinator may also manage global configuration and policy parameters for nodes, such as default safety margins, target maintenance intervals, and economic weights in reward functions. Configuration changes can be rolled out gradually across the fleet, with pilot deployments on selected nodes and monitoring of performance impacts before broader adoption. All configuration changes can be logged with timestamps and version identifiers, enabling auditability and rollback if needed.

Communication between nodes and the fleet-level coordinator may use publish-subscribe messaging patterns, with nodes publishing metrics and updates to topics and the coordinator publishing model updates and dispatch signals to node-specific or group-specific topics. Quality-of-service levels can be configured per message type, with higher reliability or lower latency reserved for time-critical control messages and more relaxed settings for bulk telemetry or training updates.

The fleet-level coordination layer may be implemented as a distributed service with multiple redundant instances to ensure high availability and scalability. Load balancing, failover, and data replication strategies can be used to maintain service continuity in the presence of hardware failures or network partitions. In some deployments, instances may be located in multiple geographic regions to comply with data localization requirements and to reduce latency for geographically distributed nodes.

While the fleet-level AI coordination module may be operated by the same entity that owns or operates the energy harvesting nodes, alternative arrangements are possible. For instance, a third-party service provider may offer fleet-level optimization and federated learning as a managed service to multiple asset owners. In such cases, multi-tenancy and data isolation features ensure that model training and dispatch decisions respect tenant boundaries and confidentiality requirements.

By coordinating learning, forecasting, and dispatch decisions across heterogeneous renewable assets and storage resources, the fleet-level AI coordination module amplifies the benefits of node-level AI control. It allows the system to respond coherently to grid and market conditions, to continuously improve models with fleet-wide experience, and to allocate optimization effort where it has the greatest impact on energy yield, asset longevity, financial performance, and environmental outcomes.

The blockchain orchestration layer maintains a tamper-evident record of validated energy production, token issuance, trades, and associated environmental credits. In one embodiment, the orchestration layer is implemented on a permissioned distributed ledger where validator nodes are operated by trusted entities such as asset owners, utilities, market operators, or independent auditors. In another embodiment, a public or consortium blockchain is used, with smart contracts and token standards selected to balance transparency, scalability, and regulatory requirements.

The data model for the ledger includes, at a minimum, records representing digital energy tokens, transaction records for trades and transfers of such tokens, and records for environmental credit tokens. Each digital energy token entry references a validated energy quantum, storing fields such as a token identifier, node or portfolio identifier, time interval over which the energy was produced, modality type, energy quantity in standard units, and optional fields such as quality classification, location region, and applicable regulatory scheme.

To link on-chain tokens to off-chain physical events, the orchestration layer receives signed summaries from energy harvesting nodes or from aggregation gateways. Each summary may contain one or more entries, each entry including a time interval, measured energy, modality, and checksums or hashes of underlying telemetry or validation reports. The summaries are signed using cryptographic keys stored in secure hardware at the node or gateway, and may include hardware attestation evidence proving that the sender is running authorized software on approved hardware.

A token minting smart contract implements rules that determine when and how digital energy tokens are created based on received summaries and associated proofs. The smart contract, or an associated off-chain validation service, verifies the authenticity of signatures, checks that the claimed energy intervals have not already been tokenized, verifies that validation flags indicate operation within required envelopes, and may apply additional eligibility rules such as jurisdictional or program-specific criteria. Only upon satisfying these conditions does the contract increase balances of digital energy tokens for the relevant account.

Trade records on the ledger capture transfers of digital energy tokens between accounts. Each trade record identifies the tokens or token quantities transferred, buyer and seller account identifiers or addresses, executed prices, timestamps, and references to any associated agreements or market mechanisms. Smart contracts may enforce that trades are atomic and final, with settlement occurring automatically upon execution, subject to any programmed conditions such as delivery windows or verification of external events.

Environmental credit tokens are recorded in a similar fashion, but are typically derived from aggregated energy tokens and associated emission factors. The orchestration layer or associated services compute avoided emissions for a set of validated energy quanta, for example by multiplying energy quantities by region-specific marginal emission factors. Credit tokens are minted for the corresponding quantity of avoided emissions and cross-referenced to the underlying energy tokens via token identifiers or batch references. Retirement of credit tokens, whether for compliance or voluntary claims, is recorded as a state change that prevents further transfer.

The ledger may incorporate sharding or partitioning mechanisms to improve scalability and align with geographic or market boundaries. For example, separate shards or sidechains may be maintained for different grid zones or regulatory regions, with cross-chain bridges facilitating transfers of tokens between regions when allowed. Sharding rules may be encoded in the ledger configuration and enforced by smart contracts or network-level protocols, ensuring that localized energy and credit markets can operate with lower latency while maintaining overall integrity.

Oracles provide external data to smart contracts, including market prices for electricity, capacity, and carbon credits; exchange rates between currencies; and, in some embodiments, regulatory status updates or certification information. Oracle feeds may be implemented via trusted gateways that relay signed data from external systems into the ledger, or via decentralized oracle networks that aggregate data from multiple sources. Smart contracts that compute dynamic pricing or eligibility for token minting can use oracle data as inputs, while still recording their decisions on-chain for auditability.

Access control within the blockchain orchestration layer may be enforced at multiple levels. At the network level, permissioned ledgers may restrict validator roles to approved entities and may restrict transaction submission from certain nodes. At the smart contract level, functions such as token minting, credit issuance, or parameter changes may be callable only by specific roles or through multi-signature approval schemes. At the data level, encryption or privacy-enhancing technologies such as zero-knowledge proofs may be used to protect sensitive details while still proving compliance with rules.

In some embodiments, the ledger includes a registry of energy harvesting nodes and associated credentials. The registry records node identifiers, owner identity, modality, capacity, geographic location, commissioning date, and attestation evidence. Node status flags, such as “active,” “suspended,” or “retired,” may be maintained and referenced by minting and trading contracts. For example, tokens may only be minted for intervals during which the node registry indicates that the node was active and in good standing.

The orchestration layer may also maintain a registry of market products and programs, such as specific tariffs, bilateral agreements, community energy schemes, or compliance programs. Each product may define eligibility criteria for energy tokens or credit tokens, such as geography, vintage, modality, or additional attributes like certifying body approvals. Smart contracts can reference this registry to enforce that tokens associated with particular products meet their definitions and constraints.

To support off-chain analysis and integration, the ledger state and event logs can be mirrored into analytic databases or data lakes via indexing services. These services subscribe to ledger events, decode transaction data, and populate structured tables and time series that can be queried by business intelligence tools, regulators, researchers, and other stakeholders. The mirrored data can be joined with external datasets such as weather records, grid status logs, and financial data to support richer analyses of system performance and impact.

Resilience and fault tolerance of the blockchain orchestration layer are achieved through replication of validator nodes, consensus protocols tolerant of byzantine faults, and backup strategies for ledger data. In the event of node failures or network partitions, consensus protocols ensure that only valid and agreed-upon transactions are committed. Regular snapshots and off-site backups can be maintained to facilitate recovery from catastrophic failures. Disaster recovery procedures may be documented and tested, especially in systems where ledger records are critical for compliance or financial reporting.

While blockchain technology is a preferred mechanism for implementing the orchestration layer due to its immutability, programmability, and distributed trust properties, alternative ledger or transaction log systems may be employed in certain embodiments. For example, a centralized or consortium-operated transaction log with cryptographic proofs of integrity, such as hash-chained logs anchored periodically to a public ledger, may be used where regulatory or performance constraints favor such designs. Regardless of the specific technology, the orchestration layer's essential role is to provide an auditable, tamper-evident record linking physical energy production and environmental attributes to digital tokens and financial transactions.

By tightly integrating node-level validation, AI-derived proofs, and ledger-recorded tokens and contracts, the blockchain orchestration layer ensures that digital representations of energy and environmental value remain grounded in verifiable physical reality. This architecture provides a foundation upon which diverse market mechanisms, financing structures, and regulatory frameworks can be built, while maintaining trust among asset owners, buyers, regulators, and other stakeholders.

Tokenization of energy production begins with the definition of quantization intervals and aggregation rules. In one embodiment, the system defines fixed-length time intervals, such as one minute, five minutes, or fifteen minutes, over which energy production is measured and validated. For each interval, the system computes the net electrical energy exported by each energy harvesting node or by groups of nodes, for example by integrating power measurements at the point of interconnection. Interval lengths may be configured per deployment or per market product, balancing temporal resolution with computational and storage overhead.

For each candidate interval, validation logic determines whether the associated energy is eligible for tokenization as a validated energy quantum. Eligibility checks may include verifying that required sensors were operational and not flagged as faulty; that node health indicators did not signal critical faults; that operating conditions fell within defined safety and regulatory envelopes; and that consistency checks between measured energy, resource conditions, and equipment ratings were satisfied. The validation logic may also verify that the node was in an “active” and “trusted” state according to the node registry in the blockchain orchestration layer.

If validation conditions are met, the system computes a validated energy quantum for the interval, expressed in a standard energy unit, such as kilowatt-hours. In some embodiments, the system may aggregate multiple intervals or multiple nodes into composite energy quanta, for example to meet minimum lot sizes for trading or to simplify accounting for community microgrids. The aggregation process preserves traceability by storing references to all underlying intervals and nodes in metadata.

For each validated energy quantum, the system constructs a tokenization request that includes the quantity of energy, the time interval(s), node or portfolio identifiers, modality type, location, applicable program or tariff identifiers, and hashes of validation reports or underlying telemetry. The tokenization request is signed by the node or gateway using cryptographic keys, and optionally augmented with signatures or attestations from additional parties such as auditors, regulators, or verification services.

The tokenization request is submitted to the token minting smart contract, which verifies signatures, checks that the referenced intervals have not been previously tokenized, and confirms that all required metadata fields are present and consistent. The contract may consult registries of nodes and programs to ensure that the requested tokens comply with program definitions and regional rules. Upon successful verification, the contract mints one or more digital energy tokens and credits them to the account of the asset owner, node operator, or designated beneficiary.

Digital energy tokens may be implemented as fungible tokens where each token represents a fixed unit of energy, such as one kilowatt-hour, or as non-fungible tokens where each token represents a unique batch or interval of energy with detailed provenance. In a fungible implementation, tokens may be distinguished by class or “pool” identifiers indicating modality, region, vintage, or certification status, while still being interchangeable within each class. In a non-fungible implementation, each token's metadata explicitly links to specific intervals and validation artifacts, suitable for high-assurance use cases.

To prevent double counting of energy or environmental attributes, the system enforces one-way linkages between validated energy quanta and digital energy tokens, and between energy tokens and environmental credit tokens. Once a given energy quantum has been tokenized, attempts to retokenize the same quantum are rejected by the minting contract. Similarly, environmental credit tokens minted based on a set of energy tokens are linked to those tokens, and retirement of the credits prevents their reuse in multiple claims.

Environmental impact metrics, such as avoided greenhouse gas emissions, may be computed for each validated energy quantum or for aggregated sets of quanta. Computation may use region-specific marginal emission factors, which estimate the emissions that would have occurred had the same quantity of energy been supplied by marginal fossil fuel generators. These factors may be sourced from regulatory authorities, grid operators, or scientific studies and may be updated periodically. The system can store the factors and the resulting emissions calculations as part of the token metadata or in associated records.

Based on computed emissions reductions, the system can mint environmental credit tokens, for example representing one metric ton of carbon dioxide equivalent avoided emissions per token. Credit tokens may be designed to conform to existing standards or registries, and may include metadata such as project identifiers, methodologies used for calculation, verification body identifiers, vintage, and usage restrictions. Smart contracts govern the lifecycle of credit tokens, including issuance, transfer, and retirement.

Smart contracts for trading digital energy tokens implement various market mechanisms. In one embodiment, an order book contract allows participants to place limit and market orders specifying token quantities, prices, and directions (buy or sell). The contract matches orders according to price-time priority and executes trades when matching orders are found. Trade execution results in transfer of token ownership and exchange of payment tokens or other agreed consideration, with transaction details recorded on the ledger.

In another embodiment, automated market maker (AMM) contracts maintain liquidity pools of digital energy tokens and payment tokens. The AMM uses a pricing function, such as a constant product, constant sum, or more complex curve, to determine prices based on pool balances. Participants can trade against the pool by supplying one token type and receiving the other, paying or earning a spread. Liquidity providers can deposit tokens into the pool and earn a share of trading fees. AMM parameters may be calibrated to reflect expected volatility and desired depth of markets in different regions or modalities.

Auction mechanisms may also be implemented via smart contracts to allocate energy tokens or forward contracts for future energy delivery. For example, periodic auctions can accept bids from buyers and offers from sellers, clear at a uniform clearing price, and allocate token quantities accordingly. Auctions can be used for day-ahead or month-ahead energy products, enabling hedging and procurement planning. Auction smart contracts enforce bidding rules, settlement procedures, and reporting of results.

Dynamic pricing rules within trading contracts can make use of AI-derived forecasts and external oracle data. For instance, pricing formulas may incorporate expected future supply from renewable sources, expected demand profiles, congestion risks, and carbon prices. These inputs can be fed into pricing models that calculate suggested prices or adjust AMM parameters. While AI-based pricing models may run off-chain for efficiency, their outputs are recorded on-chain via transactions or oracle updates, enabling auditability.

Revenue distribution logic is encoded in smart contracts that receive proceeds from trades or from off-chain settlement processes and allocate them according to predefined shares. The logic may specify fixed percentages for asset owners, maintenance funds, platform operators, community funds, and other beneficiaries, or may specify conditional rules that adjust allocations based on asset health, performance, or contractual milestones. For example, a larger share of revenue may be directed to maintenance funds when predictive maintenance models estimate lower remaining useful life across key components.

Smart contracts may support subscription-based models for AI optimization and analytics services. Asset owners can subscribe to specific service tiers by locking tokens or making periodic payments to service contracts. In return, they receive access to advanced models, reports, and optimization features. Service contracts track subscription status, manage access control to APIs and dashboards, and handle automatic renewals or cancellations based on token flows.

Governance of market parameters, such as fee rates, AMM curves, auction schedules, and eligibility rules, may be managed via governance contracts. Stakeholders, such as token holders, asset owners, or designated governance bodies, can propose and vote on parameter changes. Voting weight may be proportional to token holdings, energy contributions, or other metrics. Approved changes may be executed automatically by governance contracts, subject to timelocks or other safeguards.

The tokenization and smart contract framework described herein is designed to be extensible. New token classes, market products, and service contracts can be added over time without disrupting existing tokens and trades, provided they adhere to interface standards and compatibility constraints. This extensibility allows the system to adapt to evolving regulatory requirements, market preferences, and innovation in renewable technologies and financial instruments.

In some embodiments, privacy-enhancing technologies are employed to protect sensitive commercial information while preserving the transparency needed for verification and regulation. Techniques such as zero-knowledge proofs can be used to prove that certain conditions hold—for example, that energy was produced within a given region and under certain operating envelopes—without revealing detailed telemetry or business-sensitive data. Similarly, confidential transactions or shielded addresses can hide transaction amounts or counterparties while still enabling auditing under appropriate access controls.

Integration of the tokenization framework with external payment systems and financial institutions can be accomplished via gateway contracts and off-chain settlement APIs. For example, stablecoins or tokenized fiat currencies may be used as payment tokens in energy trades, with gateways managing redemption and fiat settlement. Alternatively, off-chain settlement systems can be integrated, where the ledger records entitlements and obligations, and external clearing systems perform actual money transfers, with settlement status fed back to the ledger.

Through the combination of validated energy quantization, cryptographically secure tokenization, programmable trading mechanisms, and configurable revenue distribution, the invention provides an infrastructure for decentralized, verifiable, and flexible markets for renewable energy and environmental value. This infrastructure is tightly coupled to physical operations through AI-driven validation and control, ensuring that digital token flows accurately reflect real-world energy flows and impacts.

Securing the interaction between physical assets, AI controllers, and the blockchain orchestration layer is critical to maintaining trust in the system. Each energy harvesting node may include a cybersecurity module that provides secure boot, firmware integrity verification, secure storage of cryptographic keys, and secure communication channels. Secure boot mechanisms ensure that only authorized firmware and software images are executed on the AI processing unit and associated controllers, by verifying digital signatures before allowing code to run.

Cryptographic keys used for signing telemetry summaries, tokenization requests, and attestation messages may be stored in hardware-backed secure elements such as trusted platform modules (TPMs), hardware security modules (HSMs), or secure enclaves. These elements protect keys against extraction even if the main operating system is compromised. The cybersecurity module may expose APIs for signing and verification operations while preventing direct access to raw key material.

During commissioning, each energy harvesting node may generate one or more cryptographic key pairs and register public keys and associated metadata with a node registry in the blockchain orchestration layer. Registration may include submission of hardware attestation evidence, such as measurements of firmware and software components taken by trusted execution environments, along with proofs that the node is operating within specified configurations. The registry assigns a unique node identifier and records its status as “provisioned” and, upon completion of initial checks, “active.”

Periodically or upon certain events, nodes may perform remote attestation to prove to the orchestration layer that they remain in a known-good state. Remote attestation messages can include hashes of installed firmware and software, configuration checksums, and timestamps, all signed by the node's secure element. The orchestration layer or associated verification services compare these measurements against expected baselines or allowlists. If discrepancies are detected, the node's status may be changed to “suspended” or “under review,” and token minting privileges may be temporarily revoked.

Network communication between nodes, fleet-level coordination services, and blockchain gateways is protected using encryption and authentication protocols such as TLS with mutual authentication. Certificates may be issued by a public key infrastructure (PKI) managed by the platform operator or by trusted third parties. Access control lists and firewall rules may restrict which endpoints can initiate or receive connections, reducing the attack surface. Network intrusion detection or anomaly detection systems may monitor traffic patterns for signs of compromise.

On the data side, the AI processing unit can run models that detect anomalies indicative of cyber or physical tampering. For example, sudden step changes in measurements that do not align with physical dynamics, repeated patterns that match known attack signatures, or discrepancies between redundant sensors can be flagged. When such anomalies are detected, the node may transition to a safe operating mode, limit or suspend tokenization requests, and generate alerts for operators and fleet-level security services.

The cybersecurity module may also enforce role-based access control for local and remote management interfaces. Different roles—such as operators, maintenance technicians, auditors, and administrators—may be granted specific permissions for tasks such as viewing telemetry, changing settings, initiating firmware updates, or overriding control policies. Strong authentication mechanisms, such as multi-factor authentication and hardware tokens, may be used for sensitive actions. Audit logs of access and configuration changes may be stored both locally and, in summarized form, on the ledger or in secure log services.

Firmware and software updates for nodes are managed through a secure update mechanism. Update packages are signed by trusted authorities and verified by nodes before installation. The update process may support staged rollouts, allowing a subset of nodes to receive updates first, with monitoring for regressions before wider deployment. In case of problems, the update mechanism may support rollback to prior versions. Update-related events and version changes may be logged in the node registry and associated with model and configuration versions used in token validation.

The platform may implement segregation of duties between entities responsible for operating nodes, managing AI models, administering the ledger, and conducting audits. For example, an independent auditor or certification body may have read-only access to telemetry summaries, tokenization logs, and attestation records, enabling them to verify compliance with standards or program requirements. Smart contracts may encode requirements that certain operations, such as changing key parameters or enabling new token classes, require multi-party approval.

In some embodiments, confidential computing technologies may be employed to further protect sensitive processing at nodes or in fleet-level services. For instance, AI models and validation logic may run within secure enclaves that protect code and data even from privileged system software. Remote attestation of these enclaves can provide additional assurance to the blockchain orchestration layer and counterparties that tokenization and control decisions are being made by authorized, untampered logic.

Recovery procedures are defined to handle situations where keys are lost or compromised, nodes are physically damaged, or ledger records need to be reconciled with off-chain data following disruptions. Key rotation mechanisms allow old keys to be retired and new keys to be issued, with appropriate updates to the node registry and token minting contracts. In the event of physical damage or replacement of a node, its identifier and historical data may be marked as retired, and a new node may be onboarded with linkage to the predecessor's records where relevant.

Market manipulation risks, such as wash trading, spoofing, or collusion, may be mitigated through a combination of smart contract rules, surveillance analytics, and governance. Smart contracts can implement limits on self-trading or require minimum holding periods for certain token classes. Surveillance systems can analyze trading patterns on the ledger for abnormal behaviors. Governance processes can enforce penalties, suspensions, or changes to market rules in response to detected abuse.

Privacy and confidentiality are addressed through selective disclosure mechanisms. While certain data, such as token identifiers and high-level trade information, may be public or widely visible, more detailed telemetry or commercial terms may be restricted to authorized parties. Encryption of payloads, pseudonymous account identifiers, and privacy-preserving proofs allow the system to balance transparency for verification with protection of sensitive information.

Overall, the cybersecurity and attestation framework ensures that only authenticated, integrity-verified nodes are able to influence tokenization and trading processes, and that attempts to falsify or manipulate data are detectable and traceable. Combined with AI-based anomaly detection and robust access controls, this framework reduces the risk that digital energy and environmental tokens diverge from underlying physical reality due to malicious or accidental actions.

In addition to security, the invention contemplates providing AI optimization and analytics as a software-as-a-service (SaaS) offering for operators whose assets may not be directly integrated into the tokenization system. Such operators may stream telemetry to cloud-based AI modules via secure interfaces, receive control recommendations, health assessments, and forecasts, and optionally integrate with the tokenization and trading framework through gateway nodes or virtual node representations.

A model and service marketplace may be hosted by the platform, allowing third-party developers and domain experts to contribute specialized AI models, analytics dashboards, or optimization strategies. Each module in the marketplace may be registered with metadata describing supported asset types, geographical applicability, input data requirements, performance metrics, and certification status. Asset owners can browse and subscribe to modules, which are then deployed either to their nodes, to fleet-level services, or both.

Marketplace modules may be sandboxed to limit their access to data and control surfaces. For example, a third-party forecasting module may be granted read-only access to weather and production data, while control adjustments remain mediated by core platform logic that enforces safety constraints. Payment for marketplace modules can be handled via smart contracts that allocate subscription fees or usage-based payments to module creators, based on metrics such as number of active nodes using the module or incremental performance improvements.

Certification and quality assurance processes for marketplace modules can involve testing on standard datasets, simulated environments, and pilot deployments. Results of such evaluations may be recorded on the ledger in the form of certification tokens or badges, linked to module identifiers and version numbers. Asset owners and regulators can consult these records to assess the trustworthiness and suitability of modules before adoption.

SaaS and marketplace offerings may support multiple business models, including per-node subscriptions, per-kilowatt or per-kilowatt-hour fees, performance-based fees tied to incremental revenue or savings, or flat-rate enterprise licenses. Smart contracts can encode these models, automate billing and settlement, and provide transparency to both providers and consumers of services. Metrics used for billing may be derived from on-chain token flows, off-chain telemetry, or a combination of both.

By exposing AI optimization and analytics as modular, composable services and by enabling a marketplace of models and tools, the invention encourages innovation and specialization while maintaining a consistent core framework for secure, verifiable, and efficient renewable energy harvesting and trading. This layered approach allows asset owners to adopt advanced capabilities incrementally and to benefit from a broader ecosystem of contributors without sacrificing control, safety, or regulatory compliance.

In residential and small prosumer embodiments, the system may be deployed at individual homes, apartment buildings, or small commercial sites equipped with rooftop or ground-mounted solar PV, small wind turbines, batteries, and electric vehicle (EV) chargers. Each site may be modeled as one or more energy harvesting nodes coupled to a local load center. The AI processing unit may be integrated into a home energy management system (HEMS) or a smart gateway device that connects behind-the-meter assets to the broader platform.

The sensor array in a residential setting may include PV string or module-level measurements, household load measurements, EV charging station metering, battery state-of-charge and state-of-health indicators, and environmental sensors such as irradiance, temperature, and, optionally, indoor comfort sensors. Smart meters or sub-meters may measure net exports or imports at the point of common coupling with the grid. The AI processing unit may acquire this telemetry through wired or wireless protocols such as Wi-Fi, Zigbee, Z-Wave, or dedicated sub-metering buses.

At the node level, AI control logic can optimize the timing of energy usage, storage charging and discharging, and EV charging sessions to reduce electricity costs, increase self-consumption of on-site renewable generation, and participate in tokenized energy markets. For example, the AI may schedule EV charging during periods of high local solar production or low market prices, while shifting discretionary loads away from peak price intervals. The AI may also decide when to export surplus energy to the grid or local microgrid versus retaining it for later use.

Where regulations and infrastructure permit, residential nodes may participate directly in peer-to-peer energy trading governed by smart contracts. Homeowners or tenants can choose preferences such as selling surplus energy to neighbors, community organizations, or particular buyer types (for example, those committed to purchasing locally produced renewable energy). The platform may present price recommendations, historical trading performance, and environmental impact metrics to help users configure their preferences.

User interfaces for residential prosumers may be provided as mobile applications, web dashboards, or in-home displays. These interfaces can show real-time and historical graphs of energy production, consumption, storage flows, EV charging, token balances, and emissions reductions. They may provide explanations of AI-driven decisions, such as why an EV charge was delayed or why exports were curtailed at a particular time. Users may be allowed to override certain AI decisions within configured safety and contractual constraints.

In community microgrid embodiments, multiple residential or small commercial prosumers are interconnected within a localized distribution network capable of operating in grid-tied or islanded modes. Each prosumer site may host one or more energy harvesting nodes, while a community-level controller coordinates shared resources such as community batteries, backup generators, or critical loads. The community controller may be implemented as a specialized node that participates in the same AI and tokenization framework as individual sites.

Within a community microgrid, the fleet-level AI coordination module may operate at the community level to optimize energy exchanges between members, schedule utilization of shared assets, and coordinate with the main grid. Dispatch and trading strategies can be tailored to community objectives, such as minimizing collective energy bills, maximizing local self-sufficiency, enhancing resilience against outages, or generating revenue through provision of ancillary services to the grid.

Governance of community microgrids can be implemented via smart contracts that encode voting mechanisms, budget allocations, and policy decisions. For example, community members may hold governance tokens or rights proportional to their energy contributions, investments, or other metrics. They may propose and vote on decisions such as adjusting pricing rules for internal energy trades, allocating community funds to infrastructure upgrades, or changing participation criteria. Governance contracts record proposals, votes, and outcomes on the ledger, ensuring transparency and auditability.

Community microgrids may implement internal tariffs or pricing schemes that differ from external utility tariffs. For instance, the community may set internal prices that reward flexible consumption, encourage consumption during local renewable peaks, or fund resilience investments. AI models may help design and periodically adjust these tariffs based on observed behavior, financial outcomes, and reliability goals. Smart contracts can enforce tariff rules automatically in tokenized transactions among members.

In islanded or resilience-oriented embodiments, community microgrids may be designed to maintain critical services such as medical facilities, water treatment, communication systems, and emergency shelters during extended grid outages. AI models can prioritize energy allocation to critical loads, dynamically curtail non-critical loads, and coordinate use of backup generators and storage. The tokenization framework can represent rights to critical energy services or emergency reserves as special-purpose tokens, which can be distributed to residents or institutions according to community policies.

Residential and community deployments may also integrate demand-side flexibility resources such as smart thermostats, heat pumps, water heaters, and controllable appliances. These devices can be represented as flexible loads controlled by AI policies at the node or community level. Telemetry from these devices can inform load-shifting strategies and participation in demand response programs. Tokenized incentives may be used to compensate households for providing flexibility services, with rewards distributed automatically via smart contracts based on measured responses.

In some embodiments, communities may form federated networks where multiple microgrids or community systems share models, best practices, and, in some cases, energy or credit trading relationships. The fleet-level coordination module can operate across such federated communities, allowing them to collectively participate in larger markets while preserving local autonomy and data sovereignty. Policies may define which data and capabilities are shared, and how benefits and risks are allocated across communities.

The system can be configured to comply with consumer protection regulations, including requirements for clear disclosure of tariffs, fees, and risks; mechanisms for dispute resolution; and data protection obligations. Smart contracts may integrate escalation paths where disputes trigger review processes involving human operators, regulators, or arbitrators. Audit logs and immutable ledger records support fair resolution by providing objective evidence of transactions, energy flows, and AI decisions.

For tenants or residents who do not own assets but participate in community schemes, virtual accounts can track their share of benefits, such as discounted energy, credits for participation in flexibility programs, or dividends from community investments. These benefits may be represented via specialized tokens or balances managed by smart contracts and presented in user interfaces alongside conventional billing information.

Integration with building management systems (BMS) and residential automation platforms allows the AI-driven energy management functions to coordinate with other building services. For example, heating, ventilation, and air conditioning (HVAC) schedules can be co-optimized with energy availability and prices, while security and safety systems remain prioritized. APIs and adaptors can map between BMS protocols and the platform's internal data models, enabling incremental adoption without wholesale replacement of existing systems.

In low-income or rural electrification contexts, community microgrids powered by the disclosed system can facilitate new financing and ownership models. For instance, pay-as-you-go or lease-to-own schemes for household-level assets can be implemented via smart contracts that receive periodic payments, adjust service levels, and transfer ownership tokens upon completion of payment schedules. AI models can help size assets for households and communities based on projected usage and affordability.

Educational and engagement tools can be integrated into residential and community interfaces to increase awareness of energy usage, climate impacts, and the functioning of the microgrid. Gamified elements, such as challenges to reduce consumption during certain periods or to increase participation in flexibility programs, can be incentivized with tokens or recognition within the community. This can strengthen community buy-in and encourage behaviors that align with system optimization objectives.

Over time, residential and community deployments can serve as rich sources of data and innovation for the broader platform. Federated learning across many homes and microgrids can improve models for small-scale PV, batteries, EV charging, and flexible loads under diverse conditions. Insights from these deployments can inform product design, policy recommendations, and scaling strategies for larger utility-scale installations.

While the specific configurations of residential and community microgrid embodiments may vary widely based on local infrastructure, regulations, and socio-economic context, they all share the core elements of the invention: AI-orchestrated control of distributed renewable and flexible assets; sensor-validated and tokenized representation of energy and environmental value; and programmable, transparent mechanisms for trading, governance, and value distribution.

These smaller-scale embodiments demonstrate that the same architectural principles used for large, utility-scale portfolios can be applied at the level of individual households and communities, enabling a continuum of deployment scales—from single homes to cities—in which AI-driven optimization and verifiable digital markets reinforce each other to accelerate renewable adoption and improve system resilience.

In utility-scale embodiments, the system may be deployed across large solar farms, wind farms, or hybrid renewable parks connected at transmission or sub-transmission voltages. Each major asset or group of assets may be represented as one or more energy harvesting nodes, with on-site control rooms hosting AI processing units and integration equipment. The fleet-level AI coordination module can operate in close collaboration with utility or independent system operator (ISO) control centers, providing forecasts, dispatch capabilities, and grid services at scales ranging from tens to hundreds of megawatts or more.

Utility-scale solar farms may comprise thousands to millions of PV modules arranged in strings and arrays with centralized or string inverters. The AI processing units at such sites may aggregate telemetry from numerous inverters, transformers, and weather stations. Models can be trained to predict farm-level and sub-array-level production based on satellite imagery, numerical weather prediction data, and historical performance. The AI may use these predictions to shape farm output in response to ramp rate limits, congestion constraints, or participation in ancillary services, such as frequency regulation or voltage support.

Large wind farms may include dozens to hundreds of turbines spread over extensive geographic areas. The system can leverage spatial correlations in wind fields to coordinate control across turbines. For example, upwind turbines can be derated or yawed slightly to reduce wake effects and improve downstream turbine performance, with AI models learning site-specific wake behaviors. Fleet-level optimization may determine how much aggregate power to bid into markets at various times, accounting for uncertainty in wind forecasts and turbine availability.

Hybrid plants that combine solar, wind, storage, and possibly dispatchable low-carbon resources, such as small hydro or gas with carbon capture, can be managed as integrated portfolios. The AI coordination module can allocate generation responsibilities among modalities based on their marginal costs, flexibility, and forecast accuracy. Storage may be deployed to absorb surplus energy during high renewable output and to discharge during low output or high price periods. Tokenization mechanisms can differentiate between instantaneous energy, capacity rights, and ancillary services provided by the hybrid plant.

In industrial embodiments, the system may be deployed at manufacturing plants, data centers, refineries, chemical facilities, mines, or ports. Such sites often host a mix of energy assets including rooftop PV, ground-mounted PV, small wind turbines, combined heat and power (CHP) units, waste-heat recovery systems, backup generators, and battery banks. Electrical loads may include large motors, furnaces, compressors, chillers, process equipment, and computing clusters. The AI processing units at these sites may be integrated with existing industrial control systems and building management systems.

Industrial AI control strategies can coordinate energy assets with production schedules and process constraints. For example, waste-heat recovery units may be throttled or scheduled to avoid interference with core processes, while still maximizing overall energy efficiency. Batteries may be used to shave peak demand charges or to provide ride-through during brief grid disturbances. AI models can also recommend process-level changes, such as shifting certain energy-intensive operations to periods of high on-site renewable production or low grid prices, subject to production targets and quality standards.

Data centers represent a particular industrial use case where cooling loads and IT workloads dominate energy consumption. The system can coordinate rooftop PV, waste-heat recovery, and batteries with AI-driven workload scheduling and cooling system optimization. Telemetry from IT equipment, cooling systems, and power distribution units can feed into AI models that balance service-level agreements, hardware temperatures, and energy costs. Tokenization mechanisms can be used to certify that certain workloads were powered by validated renewable energy, supporting “green computing” claims and products.

Ports and logistics hubs may host microgrids supplying electricity to cranes, warehouses, cold storage, and electric vehicles or vessels. Renewable assets may include solar canopies over parking areas, wind turbines, and waste-heat recovery from engines or industrial processes. The system can coordinate energy flows to support electrification of vehicles and shore power for ships, while participating in local and regional energy markets. Tokens can represent not only energy but also decarbonization of specific transport or logistics activities.

In utility-scale and industrial deployments, integration with existing SCADA, EMS, and DERMS platforms is essential. The system may expose standardized interfaces such as IEC 61850, DNP3, or OpenADR, allowing grid operators to send control signals and receive telemetry without needing to understand internal AI models or tokenization logic. Conversely, the AI coordination module may consume signals from grid operators, such as dispatch instructions, contingency events, and congestion alerts, and translate them into asset-level actions.

Financial instruments built on top of the tokenization framework can support project financing, risk management, and participation by a broader range of investors. For example, revenue-sharing tokens can represent fractional claims on future cash flows from a particular plant or portfolio. These tokens can entitle holders to periodic distributions of proceeds from energy and credit token trades, as recorded on the ledger. Smart contracts can enforce payout ratios, priority of claims, and covenants such as minimum maintenance spending.

Green bonds or sustainability-linked bonds may be structured using the platform's data and tokens. Project entities can issue bond tokens whose performance metrics, such as interest rate step-ups or step-downs, are tied to verifiable metrics including renewable energy production, emissions reductions, or reliability indices. Smart contracts can monitor these metrics based on on-chain and off-chain data and automatically adjust coupon rates or other terms according to predefined formulas.

Derivative instruments, such as forwards, futures, options, or swaps on energy tokens or environmental credit tokens, may also be implemented. These instruments can allow asset owners, utilities, and consumers to hedge price and volume risks. Smart contracts governing these derivatives can reference oracle-fed benchmarks and token prices, while maintaining collateral and margin requirements. Settlement of derivatives can be performed in tokens or via off-chain payment systems, with settlement status recorded on the ledger.

Insurance products can be closely integrated with the platform's telemetry and predictive models. Parametric insurance contracts, for example, can pay out automatically when measurable conditions, such as prolonged low wind or solar irradiance, equipment failures, or grid outages, exceed defined thresholds. AI models can improve pricing of such products by refining risk estimates based on fleet-wide experience. Insurers can access anonymized or aggregated data to calibrate models while respecting privacy constraints.

Regulatory and compliance requirements vary across jurisdictions, and the system can be configured with jurisdiction-specific profiles. These profiles may define which tokenization schemes are permitted, how environmental credits must be tracked, what data must be retained and for how long, and which entities may participate in certain markets. Compliance modules can enforce these profiles by restricting smart contract functions, validating eligibility criteria, and generating required reports for regulators.

In some jurisdictions, regulations may require that energy trades or environmental credit transfers be reported to central registries or exchanges. The platform can integrate with such registries via APIs, automatically submitting trade details or credit retirements and reconciling registry records with on-chain states. Discrepancies can be flagged for review. Where necessary, the platform can operate in a “shadow accounting” mode, mirroring official registries while providing additional granularity and analytics.

Data protection and privacy regulations, such as those governing personal data or commercially sensitive information, can be addressed through configurable data handling policies. For example, personally identifiable information related to residential users may be stored off-chain in encrypted databases, with on-chain records using pseudonymous identifiers. Access to detailed telemetry may be limited to authorized parties, while summary statistics are used for public reporting. Differential privacy techniques may be applied to aggregated datasets used for research or public communication.

Integration with enterprise resource planning (ERP), billing, and accounting systems allows token flows and energy metrics to be mapped to conventional financial and operational records. The platform can export standardized reports that translate token balances and transaction histories into recognized revenue, deferred revenue, cost of goods sold, and asset valuations. APIs can support automated reconciliation, invoicing, and cost allocation for multi-site and multi-tenant organizations.

Legacy infrastructure can be integrated using gateway devices and protocol converters. For example, older inverters or generators that lack modern communication capabilities may be interfaced via retrofitted metering and control relays, with gateway nodes emulating newer protocols to the AI platform. Over time, as equipment is upgraded, gateways can be reconfigured or removed without changing higher-level AI and tokenization logic.

The system also contemplates failure modes and resilience strategies at multiple layers. At the node level, hardware failures, sensor faults, and AI model errors are mitigated through redundancy, health monitoring, and fallback to conservative control strategies. At the fleet level, loss of connectivity to certain nodes or regions can be handled by re-optimizing dispatch based on remaining assets and by adjusting market positions. At the ledger level, consensus protocols, backups, and disaster recovery procedures maintain integrity and availability of records.

When connectivity to the blockchain orchestration layer is lost, nodes may continue to operate using local AI models and log validated energy quanta in local or regional buffers. Upon reconnection, reconciliation procedures match buffered records against existing on-chain records, resolve conflicts, and, where permitted, apply retroactive tokenization. Policies may limit the extent or time window of retroactive tokenization to reduce the risk of manipulation, with AI validation and attestation requirements applied to buffered intervals as rigorously as to real-time intervals.

At the application and user-experience level, the system anticipates a variety of interfaces tailored to different stakeholder roles, including asset owners, operators, traders, regulators, community members, and service providers. Each role may be provided with a distinct view of the underlying data and controls, with permissions enforced by access control mechanisms integrated with both the AI coordination layer and the blockchain orchestration layer. For example, traders may see token order books and price trends, while operators see asset health dashboards and dispatch recommendations.

Operator dashboards can visualize real-time and historical performance of individual assets, groups of assets, and entire portfolios. Typical displays may include power output, state-of-charge of storage systems, grid interconnection status, AI-derived health indices, remaining useful life estimates, and active alarms. Drill-down capabilities can link high-level anomalies to underlying sensor traces, model outputs, and specific events such as protection trips or control overrides. Operators can also view the impacts of AI control strategies and model changes, including side-by-side comparisons of actual versus counterfactual performance.

Trading and financial interfaces can present token balances, trade histories, open orders, realized and unrealized gains or losses, and risk metrics. Tools may allow users to define trading strategies, such as price bands, hedging rules, and portfolio diversification targets, which can be executed via smart contracts or external trading systems integrated with the ledger. Users may also be able to view environmental metrics, such as cumulative emissions reductions associated with their token holdings or trades.

Regulatory and audit interfaces can provide structured access to records required for compliance and oversight. These interfaces may include preconfigured reports for renewable portfolio standards, emissions inventories, and grid code compliance, as well as ad hoc query tools that allow auditors to trace specific tokens back to underlying validated energy quanta and associated telemetry summaries. Time-stamped logs of configuration changes, model version deployments, and governance decisions can be accessed and exported in standard formats.

To assist non-expert users, such as residential prosumers or small community operators, simplified interfaces may abstract away many details of AI models and token mechanics. These interfaces may present recommended settings and actions in plain language, along with high-level indicators such as “energy self-sufficiency,” “green energy share,” or “resilience readiness.” Explanations of AI decisions can be delivered in concise, context-aware narratives, helping users understand how their behavior and preferences influence system performance and financial outcomes.

The invention contemplates a variety of failure modes at different layers and provides mechanisms for detection, mitigation, and recovery. At the node level, failures may include sensor faults, actuator malfunctions, power electronic failures, communication link loss, and software errors in the AI processing unit. The system addresses these failures through redundancy (for example, multiple sensors for critical quantities), diagnostic tests, watchdog timers, and fallback control strategies that maintain safe operation with reduced optimization capabilities.

At the fleet coordination and orchestration layers, failures may include server outages, database corruption, network partitions, or ledger consensus disruptions. Redundant instances, replication, and failover strategies mitigate these risks. Monitoring systems track health of services and trigger automated or manual remediation procedures. In the case of ledger issues, consensus protocols and backup strategies help ensure that committed transactions remain valid and that inconsistent or partial states can be reconciled.

In the presence of prolonged disruptions at higher layers, nodes continue to operate using their last known good configurations and locally stored models. Tokenization may be suspended or limited to local logs until connectivity and orchestration are restored. When services resume, reconciliation procedures compare local records with ledger state, resolve any conflicts according to predefined rules, and, where policies allow, mint tokens for previously buffered validated energy quanta. If discrepancies or anomalies are detected during reconciliation, affected intervals may be flagged for review or excluded from tokenization.

The system provides advantages over prior art in several dimensions. Technically, it unifies control of multiple renewable modalities and storage within a common AI and sensing framework, rather than treating each modality as a separate silo. It leverages edge AI and federated learning to continuously improve control and forecasting models across heterogeneous assets without centralizing raw telemetry, thus enhancing performance while respecting privacy and bandwidth constraints. It couples physical optimization tightly with digital tokenization, ensuring that market representations of energy and environmental attributes are grounded in validated sensor data and AI-derived proofs.

Economically, the system enables new revenue streams and financing models for renewable assets of all sizes. Distributed assets that previously could not economically participate in markets can now monetize their output and flexibility via tokenized products and smart contract-based trading. Revenue-splitting logic encoded on the ledger transparently allocates proceeds among asset owners, maintenance funds, platform operators, and community beneficiaries. Integration with financial instruments, such as revenue-sharing tokens and green bonds, allows investors to gain exposure to renewable portfolios backed by high-fidelity operational data.

Environmentally, the system provides high-resolution, verifiable accounting of renewable energy production and associated emissions reductions. Environmental credit tokens can be traced to specific intervals and assets, with clear baselines and methodologies recorded in metadata. This traceability reduces risks of double counting, greenwashing, or misreporting, thereby supporting credible climate commitments and enabling more rigorous policy instruments.

From a governance perspective, the system supports programmable, transparent decision-making processes for communities, portfolios, and markets. Governance smart contracts enable stakeholders to propose, debate, and vote on parameter changes, policies, and upgrades. Immutable records of governance actions and outcomes foster accountability and can be reviewed by regulators, auditors, and community members. This approach contrasts with opaque, centrally administered systems where decisions may be difficult to reconstruct or justify.

The flexible, modular architecture of the system allows it to evolve alongside advances in AI, power electronics, communication technologies, and ledger protocols. New AI models, sensing modalities, token types, and market mechanisms can be integrated into the existing framework through well-defined interfaces and registries. Backwards compatibility and versioning strategies help ensure that existing deployments can benefit from innovations without disruptive overhauls.

Example deployments illustrate how the invention can be applied in different contexts. In one scenario, a remote island community deploys solar PV, wind turbines, batteries, and backup generators under the disclosed system. AI-driven optimization reduces diesel fuel consumption, while tokenized energy and credit products attract external investment and enable community governance of tariffs and resilience measures. In another scenario, a global portfolio of industrial sites uses the system to coordinate waste-heat recovery, PV arrays, and storage, reducing energy costs and emissions while providing verifiable data for corporate sustainability reports and green financing.

While numerous embodiments and variations have been described, they are intended to be illustrative rather than limiting. The scope of the invention encompasses any systems and methods that employ AI-orchestrated control of multi-source renewable energy harvesting and that transform validated energy production into digital tokens for trading and value distribution under a verifiable, programmable framework. The invention is defined by the claims and their legal equivalents, and all modifications, combinations, and substitutions that fall within the spirit and scope of the claims are intended to be covered.

The accompanying drawings, which are incorporated in and constitute a part of this specification, illustrate example embodiments of the invention and, together with the description, serve to explain principles of the disclosed systems and methods. It will be understood that the drawings are schematic and not necessarily to scale, and that functional blocks and connections may be implemented in hardware, software, or combinations thereof.

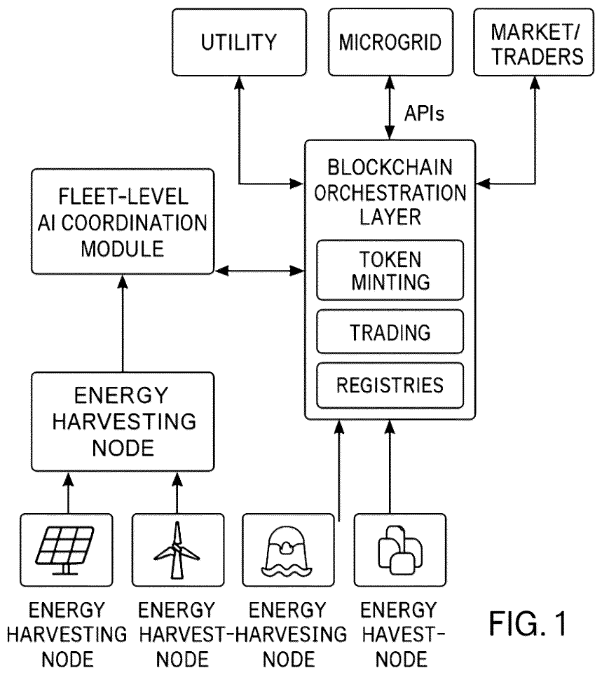

FIG. 1 is a high-level system diagram illustrating an AI-orchestrated multi-source renewable energy harvesting and decentralized trading architecture, showing a plurality of energy harvesting nodes, a fleet-level AI coordination module, a blockchain orchestration layer, and external systems coupled via application programming interfaces.

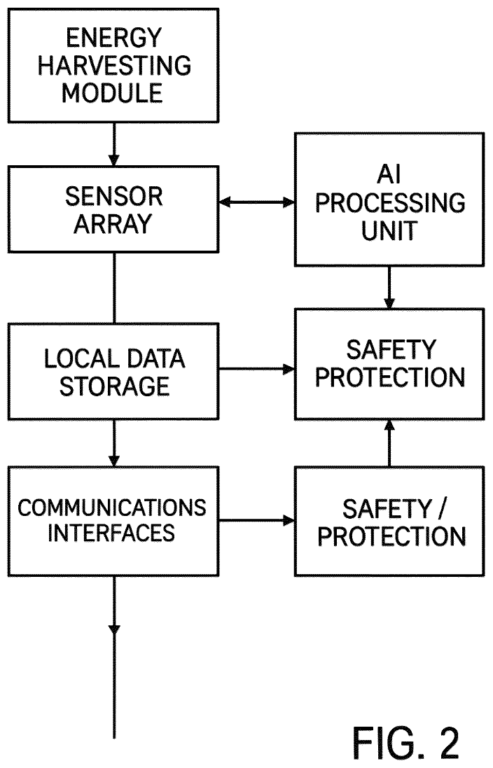

FIG. 2 is a block diagram of a representative energy harvesting node, showing an energy harvesting module, sensor array, AI processing unit, power conversion subsystem, local data storage, communications interfaces, and safety/protection components.

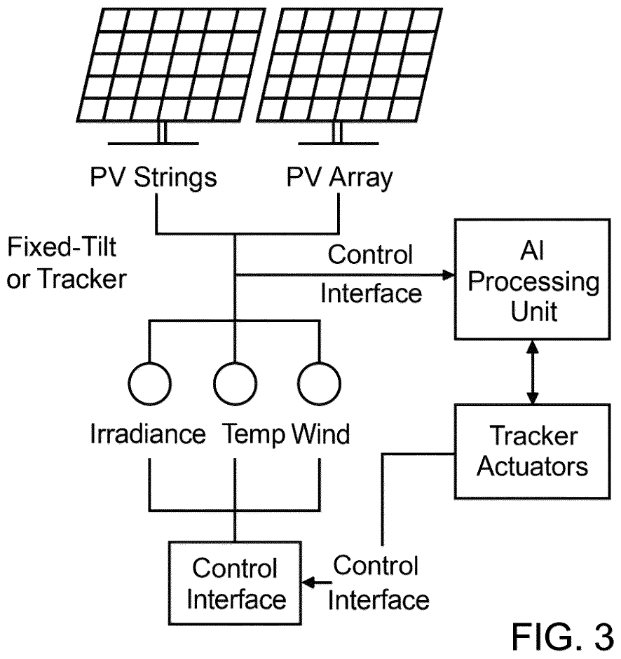

FIG. 3 is a schematic diagram of a solar photovoltaic node embodiment, showing PV strings and arrays on fixed-tilt or tracker structures, associated sensors for irradiance, temperature, and wind, and control interfaces between the AI processing unit and inverter and tracker actuators.

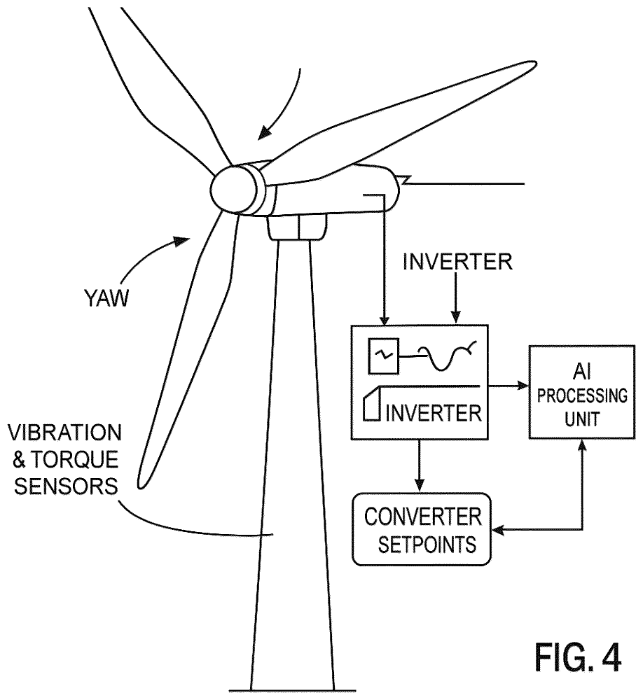

FIG. 4 is a schematic diagram of a wind turbine node embodiment, showing blades, hub, nacelle, tower, generator, vibration and torque sensors, and control interfaces for pitch, yaw, and converter setpoints under supervision of the AI processing unit.

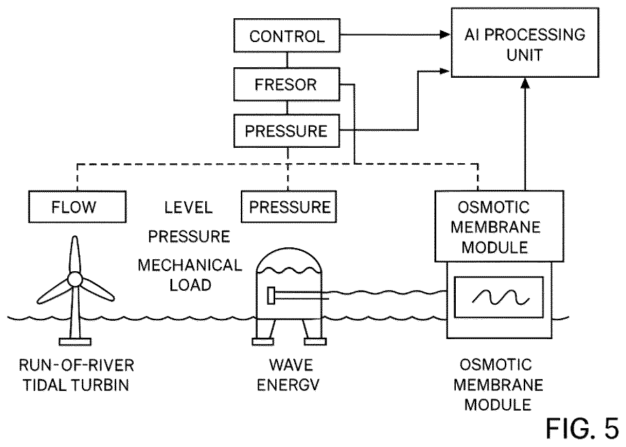

FIG. 5 is a schematic diagram of a hydrodynamic or osmotic energy harvesting node, showing run-of-river or tidal turbines, wave energy converters, or osmotic membrane modules, with flow, level, pressure, and mechanical load sensors and associated control actuators.

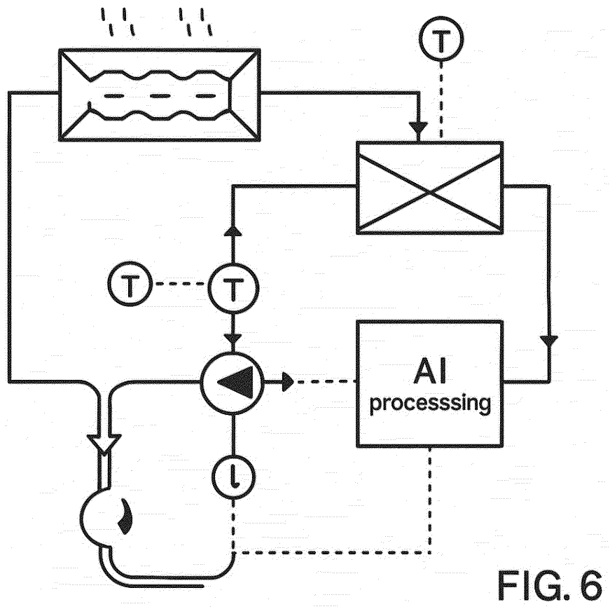

FIG. 6 is a schematic diagram of a geothermal or industrial waste-heat recovery node, showing heat exchangers, pumps, valves, a thermodynamic cycle, temperature and mass-flow sensors, and control paths for working-fluid conditions driven by the AI processing unit.

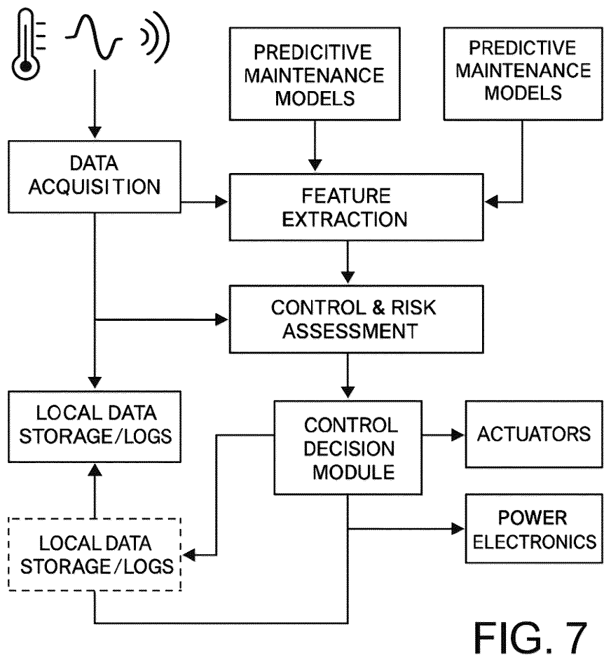

FIG. 7 is a block diagram of an edge AI control and telemetry processing pipeline at a node, showing data acquisition, preprocessing, feature extraction, predictive maintenance models, anomaly detection models, and control decision modules interfacing with actuators and power electronics.

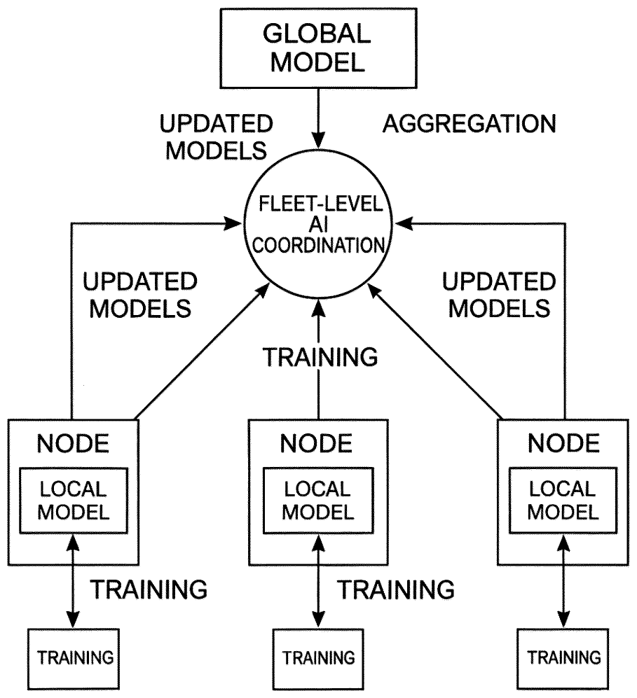

FIG. 8 is a schematic diagram of a fleet-level AI coordination and federated learning topology, showing multiple nodes training local models, transmitting model updates to a coordination module, aggregation of updates into global models, and redistribution of updated models to nodes.

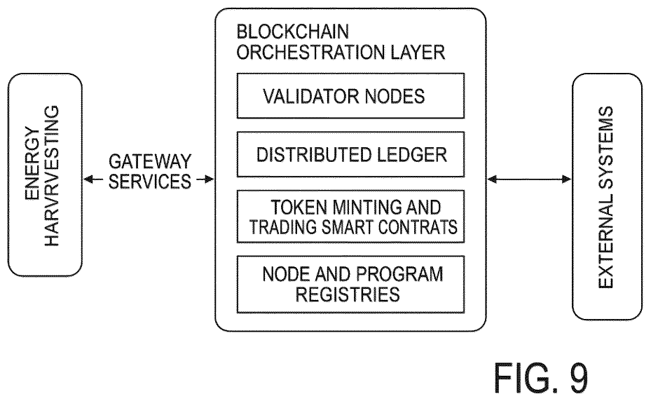

FIG. 9 is a block diagram of a blockchain orchestration layer, showing validator nodes, a distributed ledger, token minting and trading smart contracts, node and program registries, and gateway services mediating communication with energy harvesting nodes and external systems.

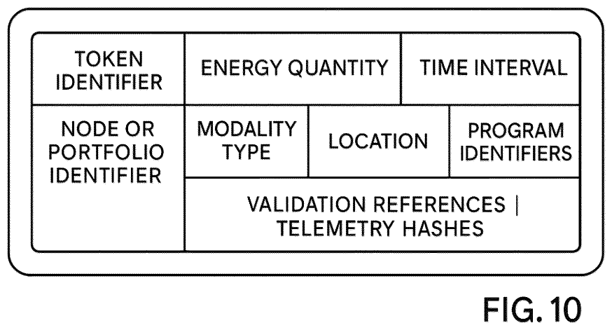

FIG. 10 is a data structure diagram of a digital energy token, illustrating fields for token identifier, energy quantity, time interval, node or portfolio identifier, modality type, location, program identifiers, and references or hashes to validation artifacts and telemetry summaries.

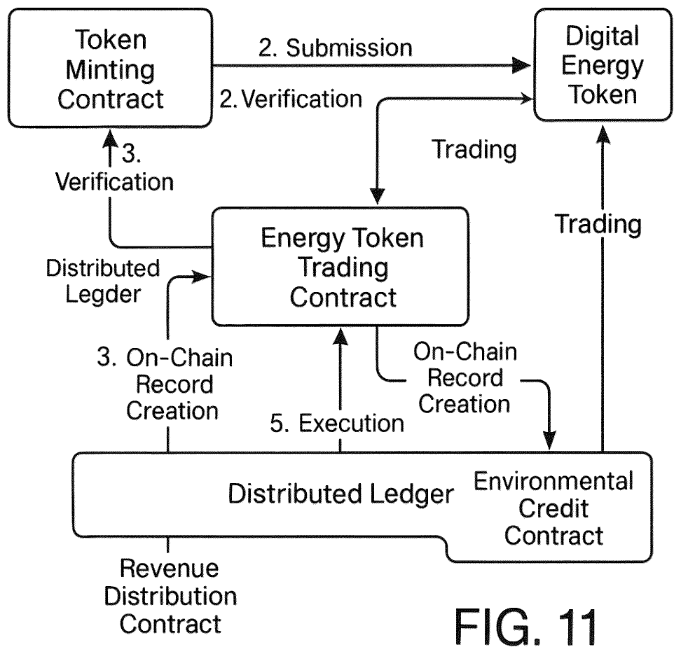

FIG. 11 is a transaction flow diagram showing interactions among smart contracts for token minting, energy token trading, revenue distribution, and environmental credit issuance, including the sequence of submissions, verifications, state updates, and on-chain record creation.

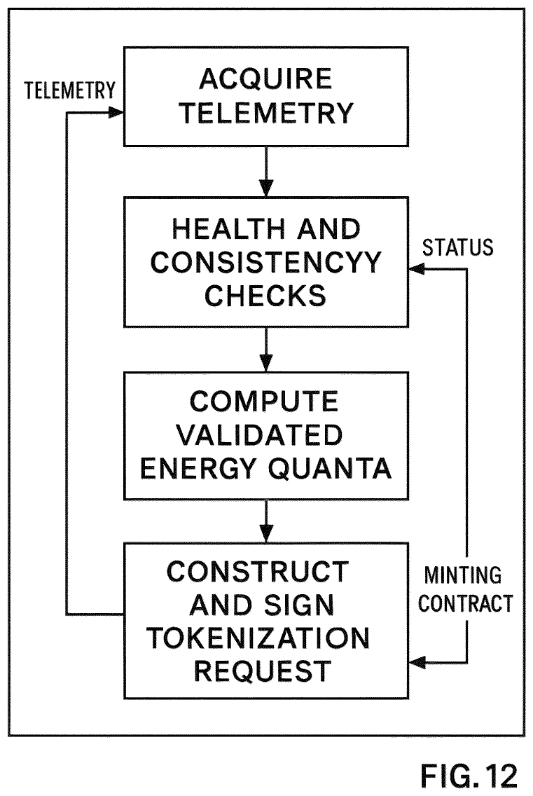

FIG. 12 is a process flow diagram illustrating validation and tokenization of energy production, showing acquisition of telemetry, health and consistency checks, computation of validated energy quanta, construction and signing of tokenization requests, and invocation of minting contracts.

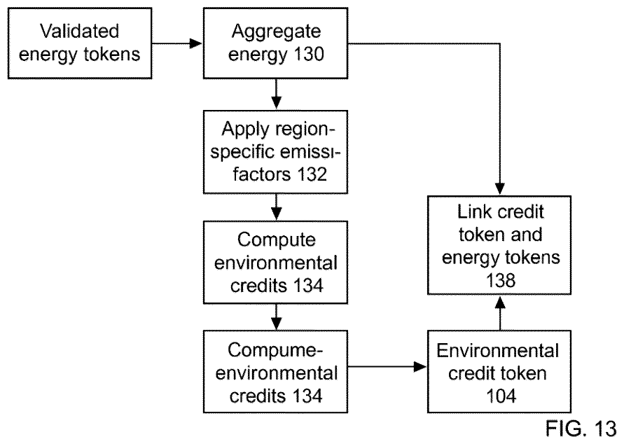

FIG. 13 is a process flow diagram illustrating computation and tokenization of environmental credits, showing aggregation of validated energy tokens, application of region-specific emission factors, minting of environmental credit tokens, and linkage between energy tokens and credit tokens.

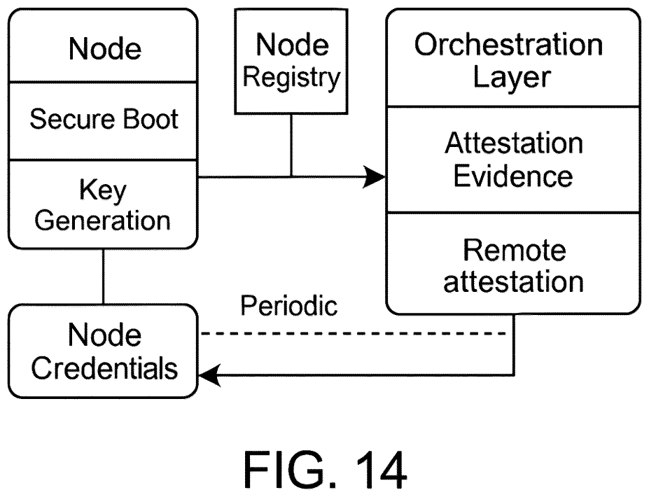

FIG. 14 is a sequence diagram illustrating node onboarding and attestation, showing secure boot, key generation, registration of node credentials with a node registry, submission of attestation evidence, and periodic remote attestation interactions with the orchestration layer.

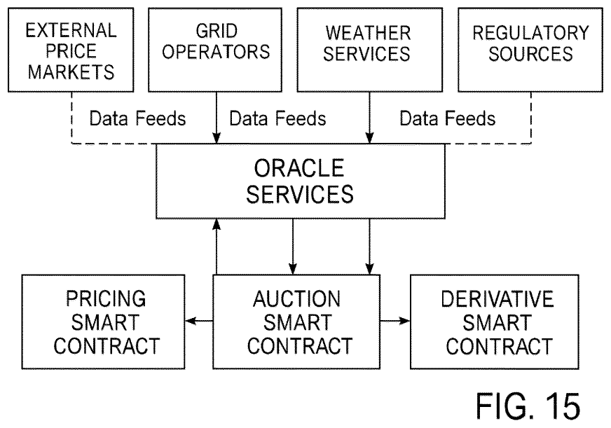

FIG. 15 is a schematic diagram of oracle and market interfaces, showing data feeds from external price markets, grid operators, weather services, and regulatory sources into oracle services, and use of oracle outputs by pricing, auction, and derivative smart contracts.

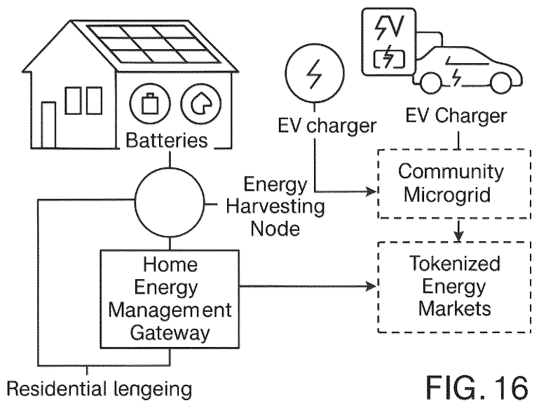

FIG. 16 is a schematic diagram of a residential or small prosumer deployment, showing rooftop PV, batteries, EV chargers, household loads, a home energy management gateway acting as an energy harvesting node, and interfaces to community microgrids and tokenized energy markets.

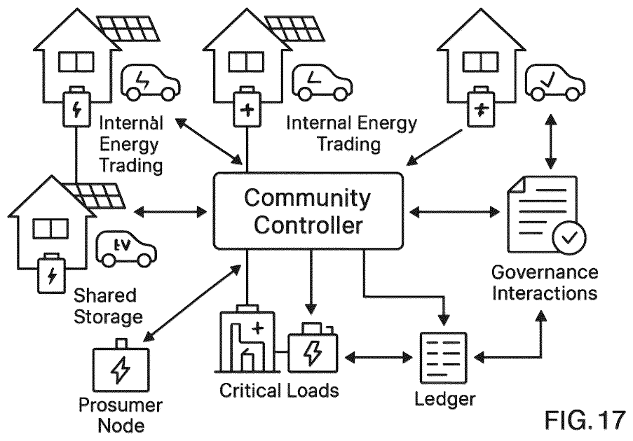

FIG. 17 is a schematic diagram of a community microgrid embodiment, showing multiple prosumer nodes, a community-level controller, shared storage and critical loads, internal energy trading flows, and governance interactions implemented via smart contracts on the ledger.

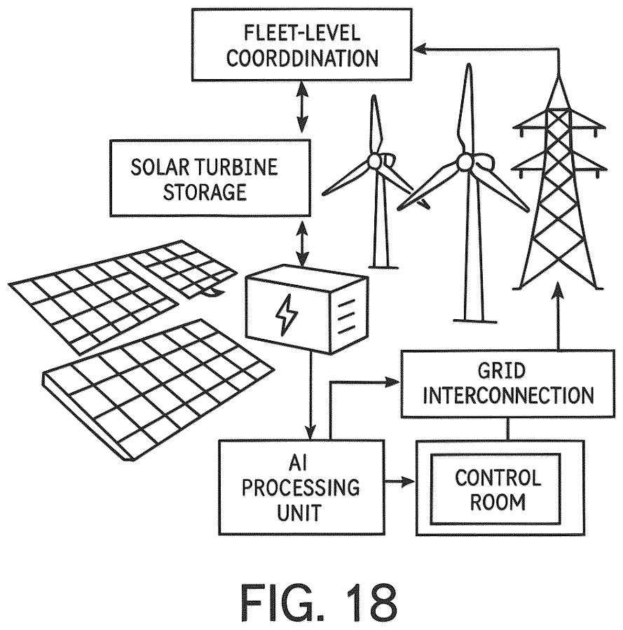

FIG. 18 is a schematic diagram of a utility-scale hybrid plant, showing co-located solar arrays, wind turbines, storage systems, grid interconnection equipment, on-site control rooms hosting AI processing units, and fleet-level coordination of dispatch and grid services.

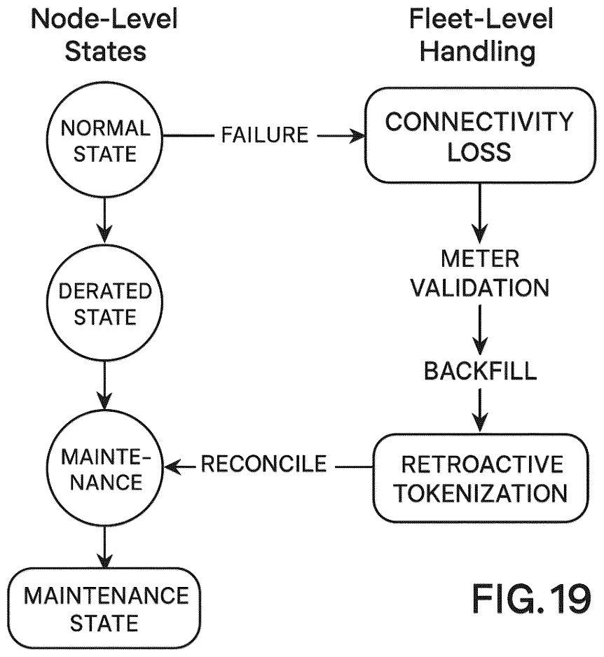

FIG. 19 is a state and event diagram illustrating representative failure modes and fallback behaviors, showing node-level transitions between normal, derated, maintenance, and fault states, fleet-level handling of connectivity loss, and reconciliation and retroactive tokenization procedures.

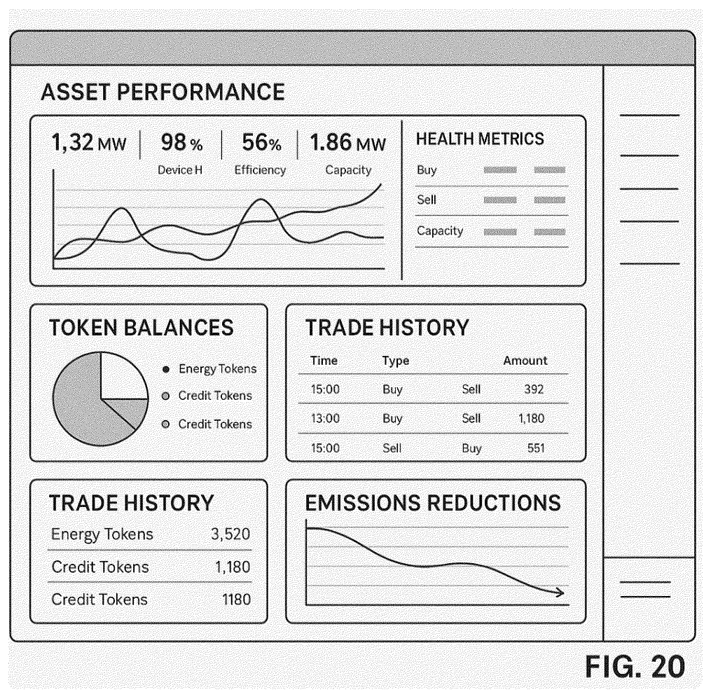

FIG. 20 is an example user interface layout illustrating dashboards for operators and stakeholders, showing visualizations of asset performance, health metrics, token balances, trade histories, and emissions reductions, along with controls for configuration, governance actions, and market participation.

Although specific embodiments and configurations have been described in detail, it should be understood that numerous variations, substitutions, and modifications are possible without departing from the scope of the invention as defined by the claims. Features described in connection with any particular embodiment may be combined with features of other embodiments, unless stated otherwise or technically incompatible. For example, particular sensor suites, AI control strategies, tokenization schemes, or market mechanisms illustrated in one context may be applied in other contexts, such as between residential, industrial, and utility-scale deployments.

The order in which operations, processes, or method steps are described is not intended to be limiting. Unless expressly stated otherwise, certain operations may be performed in different orders, in parallel, or omitted entirely, and additional operations may be added without departing from the inventive concepts. Similarly, boundaries between functional blocks, modules, and components are drawn for clarity and do not necessarily dictate rigid partitioning in implementation. A single physical or logical component may perform functions described as being distributed among multiple components, and vice versa.

Implementations of the invention may be realized in digital electronic circuitry, analog circuitry, special-purpose hardware, programmable logic, firmware, software, or combinations thereof. Control logic, AI models, and smart contract functions may be embodied as instructions stored on non-transitory computer-readable media and executed by one or more processors. Distributed implementations in which different portions of the functionality are executed on different physical devices or in different locations, including cloud environments and edge devices, are contemplated.

While the description frequently refers to blockchain and related distributed ledger technologies, the invention is not limited to any particular consensus algorithm, token standard, or ledger protocol. Future or alternative mechanisms that provide tamper-evident recording of transactions and programmable execution of rules may be substituted. Similarly, references to particular AI techniques-such as supervised learning, reinforcement learning, federated learning, and anomaly detection—are illustrative; other machine learning or optimization methods that achieve similar control, validation, or forecasting goals may be employed.

Units, thresholds, and numerical values provided herein (for example, power ratings, time intervals, or emission factors) are illustrative and not limiting, unless explicitly recited in the claims. Implementers may select values based on engineering tradeoffs, regulatory requirements, and economic considerations. The same applies to choices of communication protocols, cryptographic primitives, and security mechanisms; alternatives that provide equivalent or improved properties may be used.

In some jurisdictions, aspects of the invention may be implemented in ways that separate regulated functions, such as utility operations or financial services, from non-regulated technology services, for example by allocating responsibilities among different legal entities that interoperate via the disclosed interfaces and smart contracts. Such organizational decompositions do not alter the technical nature of the systems and methods and are intended to fall within the scope of the invention where they employ the described mechanisms for AI-orchestrated energy harvesting and tokenized representation of energy and environmental attributes.

The terminology used in the description is intended to be interpreted in a broad, non-limiting manner. Where the specification or claims refer to “at least one” of a set of items, this phrase encompasses any one or more of the items, including all of them. Where ranges of values are provided, the endpoints and any values therebetween are contemplated. Where open-ended terms such as “including,” “comprising,” or “having” are used, they are intended to mean “including but not limited to,” unless otherwise specified.

Headings and figure references are provided for convenience and do not limit the interpretation of the specification. References to “FIG. X” are to the corresponding drawing for ease of understanding; however, the inventive concepts are not restricted to the exact layouts, shapes, or proportions depicted. Functional equivalence, rather than exact graphical representation, governs the scope of protection for structural and procedural elements.

Accordingly, it is intended that the appended claims and their legal equivalents define the scope of the invention, and that the description and drawings be regarded as illustrative rather than restrictive.

1. A system for AI-orchestrated multi-source renewable energy harvesting and decentralized energy trading, comprising:
a plurality of geographically distributed energy harvesting nodes, each energy harvesting node comprising:
(i) an energy harvesting module configured to convert at least one renewable resource selected from solar irradiance, wind, hydrodynamic flow, salinity gradient, geothermal heat, and waste-heat streams into electrical power;
(ii) a sensor array embedded in or operatively coupled to the energy harvesting module and configured to measure in real time one or more parameters selected from irradiance, wind speed, flow rate, pressure, temperature, vibration, rotational speed, power factor, and component-degradation indicators;
(iii) an AI processing unit communicatively coupled to the sensor array and to one or more actuators associated with the energy harvesting module, the AI processing unit executing machine-learning models trained on physical models and historical operating data to
(A) compute health and consistency checks on incoming telemetry,
(B) predict performance degradation and failure modes of the energy harvesting module, and
(C) determine control actions that adjust operating setpoints including at least one of orientation, pitch, flow control, coolant flow, and power-electronic parameters to maximize net power output subject to component-stress constraints;
(iv) a power conversion subsystem electrically coupled to the energy harvesting module and comprising power-electronic circuitry configured to condition generated electrical power and deliver the generated electrical power to at least one of an energy-storage device, a microgrid, and a utility grid;
a validation and tokenization pipeline executed by at least one computing system and configured to:
(i) receive sensor telemetry and power-output summaries from the plurality of energy harvesting nodes;
(ii) process the sensor telemetry and the power-output summaries using one or more AI models to validate that harvested energy satisfies predefined operating, safety, and environmental constraints and to compute validated energy quanta; and
(iii) cryptographically bind each validated energy quantum to corresponding telemetry and validation results and to mint a corresponding digital energy token representative of the validated energy quantum;
a blockchain orchestration layer configured to maintain a distributed ledger storing the digital energy tokens and transaction records and to execute smart contracts for minting, trading, settlement, and revenue distribution of the digital energy tokens;
a fleet-level AI coordination module configured to implement federated learning across the plurality of energy harvesting nodes by aggregating model-parameter updates computed locally at the nodes without requiring raw sensor data to leave the nodes and to redistribute updated global model parameters to the nodes; and
one or more application-programming interfaces configured to expose energy-production data, token balances, and optimization recommendations to external utility, microgrid, and asset-management systems;
wherein the blockchain orchestration layer is further configured to authorize minting of a digital energy token only when the validation and tokenization pipeline has generated a corresponding validated energy quantum whose cryptographic binding to node telemetry and AI validation results satisfies attestation rules enforced by the smart contracts.

2. An apparatus for AI-orchestrated renewable energy harvesting, comprising:
an energy harvesting module configured to convert at least one renewable resource selected from solar irradiance, wind, hydrodynamic flow, salinity gradient, geothermal heat, and waste-heat streams into electrical power;
a sensor array embedded in or operatively coupled to the energy harvesting module, the sensor array configured to measure in real time one or more parameters selected from irradiance, wind speed, flow rate, pressure, temperature, vibration, rotational speed, power factor, and component-degradation indicators;
an AI processing unit communicatively coupled to the sensor array and to one or more actuators associated with the energy harvesting module, the AI processing unit executing machine-learning algorithms trained on physical models and historical operating data to
(i) predict performance degradation and failure modes of the energy harvesting module, and
(ii) compute control actions that adjust operating setpoints including at least one of orientation, pitch, flow control, coolant flow, and power-electronic parameters to maximize net power output subject to component-stress constraints; and
a power conversion subsystem electrically coupled to the energy harvesting module, the power conversion subsystem comprising power-electronic circuits configured to condition the generated electrical power and deliver the generated electrical power to at least one of an energy-storage device, a microgrid, and a utility grid;
wherein the AI processing unit is configured to update the control actions based on incoming sensor data at intervals of less than one minute to increase energy yield and extend component lifetime relative to operation without AI optimization.

3. A computer-implemented method for decentralized trading of renewable energy generated by a plurality of energy harvesting nodes, the method comprising:
harvesting electrical energy at each energy harvesting node using an apparatus according to claim 2 while recording sensor telemetry and power output;
processing, by one or more AI models, the sensor telemetry and the power output to perform health and consistency checks, to validate that harvested energy satisfies predefined operating, safety, and environmental constraints, and to forecast near-term energy yield;
aggregating validated harvested energy into discrete energy quanta and tokenizing each energy quantum as a respective digital energy token on a distributed ledger, each digital energy token including provenance metadata comprising at least a node identifier, a time interval, a modality type of underlying energy, and one or more cryptographic references to corresponding telemetry and AI validation results;
executing one or more smart contracts on the distributed ledger to perform peer-to-peer trading of the digital energy tokens between buyers and sellers, the one or more smart contracts implementing dynamic pricing rules that take as input AI-derived supply and demand forecasts and optionally external market data; and
distributing, upon settlement of each trade, transaction proceeds according to revenue-splitting logic encoded in the one or more smart contracts, the revenue-splitting logic including allocations to at least one of a maintenance fund, a platform-operator account, and a carbon- or environmental-credit reserve;
wherein the one or more smart contracts permit minting of each digital energy token only when validity conditions encoded in the smart contracts are satisfied by the cryptographic references to the corresponding telemetry and AI validation results.

4. The apparatus of claim 2, wherein the energy harvesting module comprises a solar photovoltaic array mounted on at least one single-axis or dual-axis tracker and the one or more actuators include tracker drives, and wherein the AI processing unit is configured to compute orientation trajectories that jointly optimize energy capture and mechanical-fatigue accumulation.

5. The apparatus of claim 2, wherein the energy harvesting module comprises a wind turbine having variable blade-pitch and yaw control, the sensor array includes nacelle vibration sensors and wind-direction sensors, and the AI processing unit is configured to perform condition-based maintenance scheduling and gust-responsive pitch control.

6. The apparatus of claim 2, wherein the energy harvesting module comprises at least one hydrodynamic device selected from run-of-river turbines, tidal turbines, wave-energy converters, and osmotic-membrane modules, the sensor array includes flow sensors and pressure sensors, and the AI processing unit is configured to adapt control actions to tidal cycles, river-discharge variations, and wave spectra.

7. The apparatus of claim 2, wherein the energy harvesting module comprises a geothermal system or an industrial waste-heat recovery system including at least one heat exchanger and a thermodynamic cycle, the sensor array includes temperature sensors and mass-flow sensors, and the AI processing unit is configured to adjust working-fluid conditions to maximize thermal-to-electric conversion efficiency while respecting temperature and pressure limits.

8. The apparatus of claim 2, wherein the power conversion subsystem comprises one or more DC-DC converters, inverters, and protection relays configured to interface with both direct-current storage and alternating-current grid connections and to support islanded, grid-tied, and black-start modes of operation.

9. The apparatus of claim 2, wherein the AI processing unit is implemented as a low-power edge-computing platform including a central processing unit and at least one of a graphics processing unit, a tensor accelerator, and a neural processing unit, and is configured to perform on-device inference and local policy updates without continuous cloud connectivity.

10. The method of claim 3, wherein processing the sensor telemetry further comprises applying a reinforcement-learning algorithm to update control policies for at least one class of energy-harvesting modules, the reinforcement-learning algorithm receiving a reward signal proportional to net kilowatt-hours exported and penalizing excessive mechanical or thermal stress.

11. The method of claim 3, wherein tokenizing the validated harvested energy comprises minting fungible tokens compatible with an ERC-20-style standard for homogeneous energy units and minting non-fungible tokens compatible with an ERC-721-style standard for unique energy batches that embed detailed provenance and compliance metadata.

12. The method of claim 3, wherein executing the one or more smart contracts further comprises integrating oracle feeds providing external market prices for at least one of electricity, capacity, and carbon credits, and adjusting token pricing using at least one of automated market-maker curves and auction mechanisms.

13. The method of claim 3, wherein distributing the transaction proceeds comprises allocating a configurable percentage of the transaction proceeds to a smart-contract-governed maintenance wallet, the configurable percentage being dynamically adjusted based on AI-inferred remaining-useful-life metrics across contributing energy-harvesting nodes.

14. The method of claim 3, further comprising computing environmental-impact metrics from the validated harvested energy using baseline emission factors for displaced fossil-fuel generation, minting carbon or environmental-credit tokens in proportion to avoided emissions, and recording cross-references between the carbon or environmental-credit tokens and the corresponding digital energy tokens on the distributed ledger.

15. The method of claim 3, further comprising, when connectivity between at least one energy-harvesting node and the distributed ledger is temporarily unavailable, buffering locally signed validation records and, upon reconnection, reconciling the buffered records with the distributed ledger to mint digital energy tokens for a bounded historical interval while preventing double counting.

16. The system of claim 1, wherein each energy-harvesting node includes mechanical and electrical interfaces that enable modular scaling from approximately one kilowatt to at least one hundred megawatts by adding or removing energy-harvesting modules, and wherein the fleet-level AI coordination module is configured to recalculate optimal dispatch profiles as energy-harvesting modules are added, reconfigured, or decommissioned.

17. The system of claim 1, wherein the blockchain orchestration layer implements transaction sharding by geographic region or grid zone such that trades among energy-harvesting nodes in a same region are processed with lower latency than trades across different regions.

18. The system of claim 1, wherein the fleet-level AI coordination module is configured to aggregate gradient updates or compressed model deltas from local AI processing units at the energy-harvesting nodes, perform a federated-averaging operation on the gradient updates or compressed model deltas, and periodically distribute updated global model parameters back to the energy-harvesting nodes.

19. The system of claim 1, wherein the smart contracts further implement subscription-based access to AI optimization and analytics services as a software-as-a-service offering to operators of renewable-energy assets, including renewable-energy assets that are not natively part of the plurality of energy-harvesting nodes, and track usage of such services using the digital energy tokens or separate utility tokens.

20. The apparatus of claim 2, further comprising a cybersecurity module configured to provide secure boot, firmware signing, and hardware-backed key storage for the AI processing unit and communication interfaces, wherein the cybersecurity module is further configured to generate attestation evidence bound to the apparatus, and wherein the attestation evidence is consumable by the blockchain orchestration layer of the system of claim 1 to restrict token-minting privileges to energy-harvesting nodes presenting valid cryptographic attestations.
